(19) United States
(12) Patent Application Publication
(10) Pub. No.: US 2022/0317972 A1
(43) Pub. Date: Oct. 6, 2022

(54) HARDWARE FOR CONCURRENT SINE AND COSINE DETERMINATION

(71) Applicant: Micron Technology, Inc., Boise, ID (US)

(72) Inventors: Douglas Vanesko, Dallas, TX (US); Tony M. Brewer, Plano, TX (US); Bryan Hornung, Plano, TX (US); Patrick Estep, Rowlett, TX (US)

(21) Appl. No.: 17/405,368

(22) Filed: Aug. 18, 2021

Related U.S. Application Data
(60) Provisional application No. 63/168,116, filed on Mar. 30, 2021.

(51) Int. Cl. G06F 7/548

(52) U.S. Cl. CPC G06F 7/548

(57) ABSTRACT

Devices and techniques for hardware for concurrent SINE and cosine determination are described herein. A first sequence of bits representing an angle of a line from an origin to a unit circle can be obtained. A quadrant of the unit circle for the line is determined and the two least significant bits of the first sequence of bits is replaced with an encoding for the quadrant, the angle is translated to a base quadrant angle and sin and cosine operations are performed on a portion of a second sequence of bits (derived from the first sequence of bits) to create intermediate sin and cosine solutions in the base quadrant. The quadrant encoding in the first sequence of bits is then used to create a final sin and cosine solutions in the quadrant from the intermediate solutions.

### CLAIM OF PRIORITY

This patent application claims the benefit of priority, under 35 U.S.C. § 119, to U.S. Provisional Application Ser. No. 63/168,116, titled “HARDWARE FOR CONCURRENT SIN AND COSINE DETERMINATION” and filed on Mar. 30, 2021, the entirety of which is hereby incorporated by reference herein.

### STATEMENT REGARDING GOVERNMENT SUPPORT

This invention was made with Government support under Agreement No. HR0011-19-3-0002, awarded by DARPA. The Government has certain rights in the invention.

### BACKGROUND

Various computer architectures, such as the Von Neumann architecture, conventionally use a shared memory for data, a bus for accessing the shared memory, an arithmetic unit, and a program control unit. However, moving data between processors and memory can require significant time and energy, which in turn can constrain performance and capacity of computer systems. In view of these limitations, new computing architectures and devices are desired to advance computing performance beyond the practice of transistor scaling (i.e., Moore's Law).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates generally a first example of a first memory-compute device in the context of a memory-compute system, according to an embodiment.

FIG. 2 illustrates generally an example of a memory subsystem of a memory-compute device, according to an embodiment.

FIG. 3 illustrates generally an example of a programmable atomic unit for a memory controller, according to an embodiment.

FIG. 4 illustrates an example of a hybrid threading processor (HTP) accelerator of a memory-compute device, according to an embodiment.

FIG. 5 illustrates an example of a representation of a hybrid threading fabric (HTF) of a memory-compute device, according to an embodiment.

FIG. 6 illustrates a unit circle with angle and quadrant relationships to sin and cosine, according to an embodiment.

FIG. 7 illustrates an example of data flow of a fixed width value through hardware for concurrent sin and cosine determination, according to an embodiment.

FIG. 8A illustrates generally an example of a chiplet system, according to an embodiment.

FIG. 8B illustrates generally a block diagram showing various components in the chiplet system from the example of FIG. 8A.

FIG. 9 illustrates generally an example of a chiplet-based implementation for a memory-compute device, according to an embodiment.

FIG. 10 illustrates an example tiling of memory-compute device chiplets, according to an embodiment.

FIG. 11 is a flow chart of an example of a method for hardware for concurrent SINE and cosine determination, according to an embodiment.

FIG. 12 illustrates a block diagram of an example machine with which, in which, or by which any one or more of the techniques (e.g., methodologies) discussed herein can be implemented.

### DETAILED DESCRIPTION

Recent advances in materials, devices, and integration technology, can be leveraged to provide memory-centric compute topologies, Such topologies can realize advances in compute efficiency and workload throughput, for example, for applications constrained by size, weight, or power requirements. The topologies can be used to facilitate low-latency compute near, or inside of, memory or other data storage elements. The approaches can be particularly well-suited for various compute-intensive operations with sparse lookups, such as in transform computations (e.g., fast Fourier transform computations (FFT)), or in applications such as neural networks or artificial intelligence (AI), financial analytics, or simulations or modeling such as for computational fluid dynamics (CFD), Enhanced Acoustic Simulator for Engineers (EASE), Simulation Program with Integrated Circuit Emphasis (SPICE), and others.

Systems, devices, and methods discussed herein can include or use memory-compute systems with processors, or processing capabilities, that are provided in, near, or integrated with memory or data storage components. Such systems are referred to generally herein as compute-near-memory (CNM) systems. A CNM system can be a node-based system with individual nodes in the systems coupled using a system scale fabric. Each node can include or use specialized or general purpose processors, and user-accessible accelerators, with a custom compute fabric to facilitate intensive operations, particularly in environments where high cache miss rates are expected.

In an example, each node in a CNM system can have a host processor or processors. Within each node, a dedicated hybrid threading processor can occupy a discrete endpoint of an on-chip network. The hybrid threading processor can have access to some or all of the memory in a particular node of the system, or a hybrid threading processor can have access to memories across a network of multiple nodes via the system scale fabric. The custom compute fabric, or hybrid threading fabric, at each node can have its own processor(s) or accelerator(s) and can operate at higher bandwidth than the hybrid threading processor. Different nodes in a compute-near-memory system can be differently configured, such as having different compute capabilities, different types of memories, different interfaces, or other differences. However, the nodes can be commonly coupled to share data and compute resources within a defined address space.

In an example, a compute-near-memory system, or a node within the system, can be user-configured for custom operations. A user can provide instructions using a high-level programming language, such as C/C++, that can be compiled and mapped directly into a dataflow architecture of the system, or of one or more nodes in the CNM system. That is, the nodes in the system can include hardware blocks (e.g., memory controllers, atomic units, other customer accelerators, etc.) that can be configured to directly implement or support user instructions to thereby enhance system performance and reduce latency.

In an example, a compute-near-memory system can be particularly suited for implementing a hierarchy of instructions and nested loops (e.g., two, three, or more, loops deep, or multiple-dimensional loops). A standard compiler can be used to accept high-level language instructions and, in turn, compile directly into the dataflow architecture of one or more of the nodes. For example, a node in the system can include a hybrid threading fabric accelerator. The hybrid threading fabric accelerator can execute in a user space of the CNM system and can initiate its own threads or sub-threads, which can operate in parallel. Each thread can map to a different loop iteration to thereby support multi-dimensional loops, With the capability to initiate such nested loops, among other capabilities, the CNM system can realize significant time savings and latency improvements for compute-intensive operations.

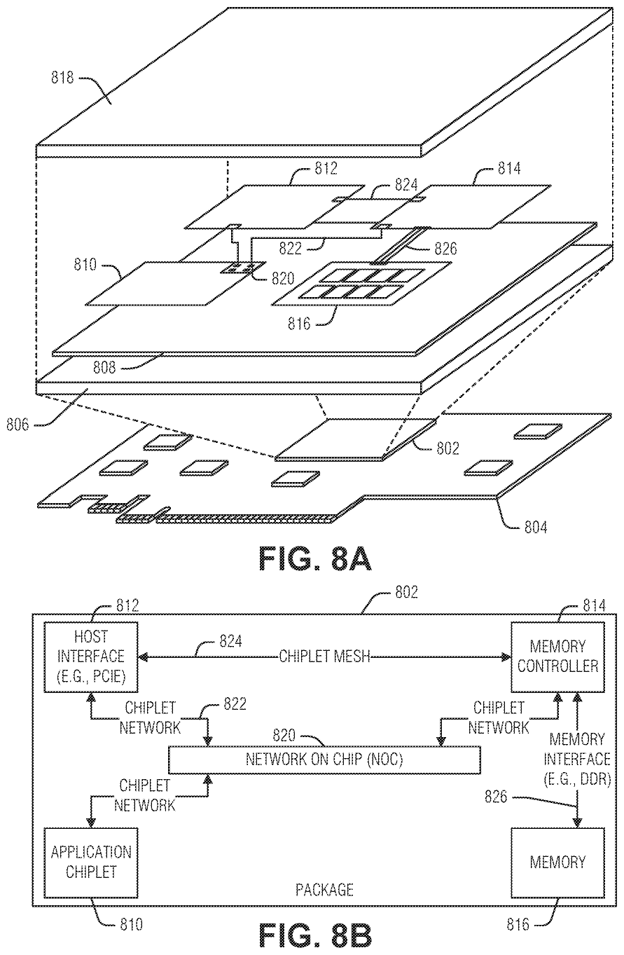

A compute-near-memory system, or nodes or components of a compute-near-memory system, can include or use various memory devices, controllers, and interconnects, among other things. In an example, the system can comprise various interconnected nodes and the nodes, or groups of nodes, can be implemented using chiplets. Chiplets are an emerging technique for integrating various processing functionality. Generally, a chiplet system is made up of discrete chips (e.g., integrated circuits (ICs) on different substrate or die) that are integrated on an interposer and packaged together. This arrangement is distinct from single chips (e.g., ICs) that contain distinct device blocks (e.g., intellectual property (IP) blocks) on one substrate (e.g., single die), such as a system-on-a-chip (SoC), or discretely packaged devices integrated on a board. In general, chiplets provide production benefits than single die chips, including higher yields or reduced development costs. FIG. 8A and FIG. 8B, discussed below, illustrate generally an example of a chiplet system such as can comprise a compute-near-memory system.

Compute-near memory systems can be useful to efficiently process a variety of workloads, especially those with numerous calculations done in parallel, such as signal processing, graphics rendering, artificial intelligence, etc. A common operation performed, for example in signal processing, is Euler's formula, e^{-ix}=cos(−x)+i sin(−x). Concurrently calculating sin and cosine when computing Euler's formula is valuable to reduce the time for the computation. With a typical processing pipeline scenario of receiving the value x as an input, parallel computation of the formula would duplicate the value to compute the cosine and sin individually. While effective, such an approach can waste communication resources (e.g., lines, lanes, busses, etc.) between the processing components, reducing overall efficiency of the hardware implementing the Euler's formula calculation.

To address the hardware inefficiencies in a straightforward implementation of Euler's formula, hardware can implement a technique that quantifies in what quadrant of the unit circle the solution will be found (e.g., based on the angle represented by the input value x) and reduce the input value (e.g., by half) such that the communication to process the cosine and the sin can occur simultaneously. In an example, specific hardware (e.g., blocks, units, etc.) can implement these functions to improve throughput. In an example, a set of special hardware operations can be used to avoid explicit branching operations to perform these operations because branch operations are extremely inefficient for single-instruction-multiple-data (SIMD) processing architectures (e.g., such as the HTF described herein).

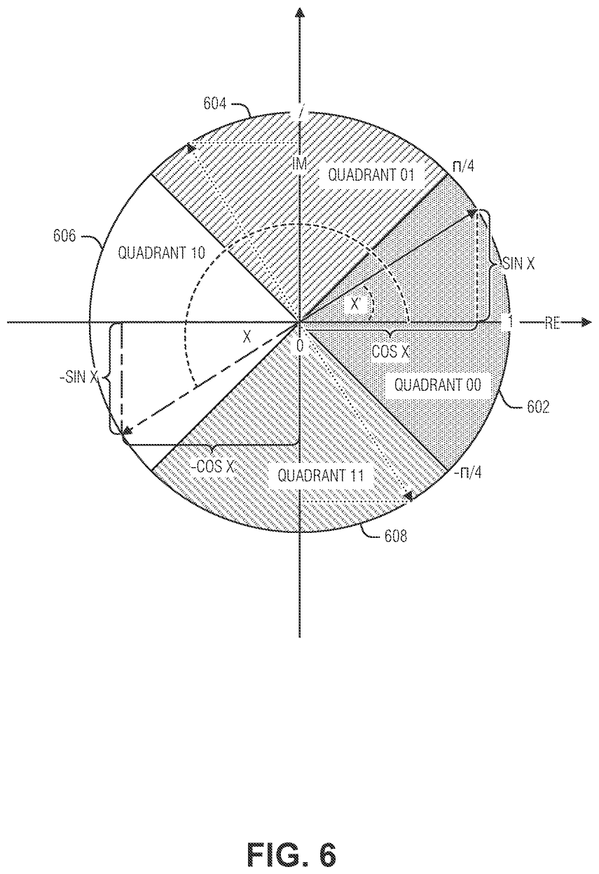

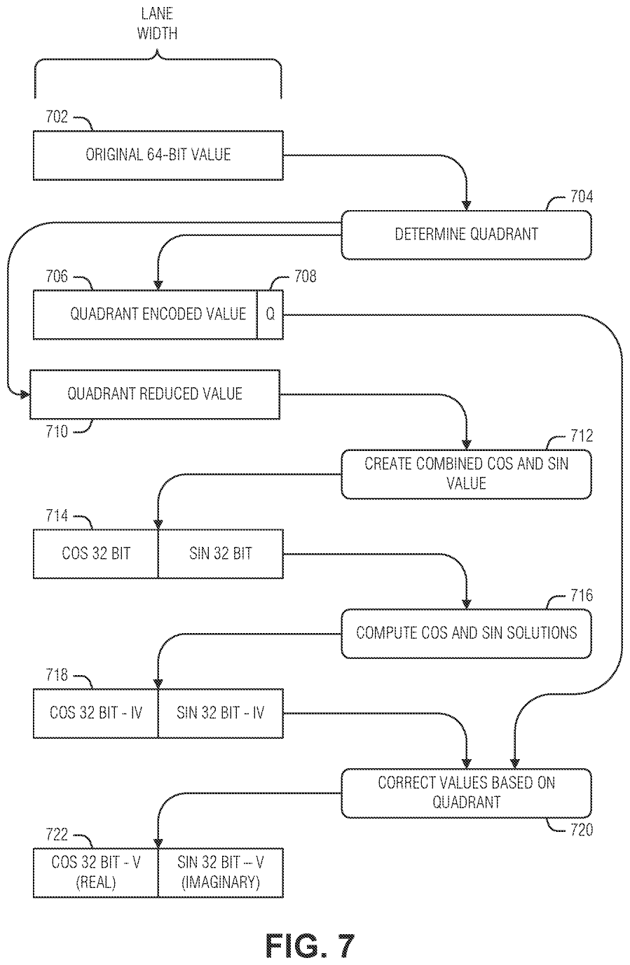

For example, the HTF can include hardware to implement instructions TruncLsbsF64, PMullgnore2Lsbs, and NegCF32FromTruncLsbsF64 (all described below) that can be used to simultaneously perform sin and cosine on a double value. These instructions reuse the least two significant bits of the operand to store the angle's quadrant. The two bits are ignored while performing a multiply to arrive at intermediate cosine and sin results and then used to change the resulting position (e.g., whether to leave the intermediate cosine and sine results or switch them with each other) and the sign (e.g., positive of negative) to arrive at the final result. Because digital signal processing often uses both the sin and cosine of a double value, expeditiously processing these operations provides a faster and more energy efficient use of the hardware. Additional details and examples are provided below, with the discussion surrounding FIGS. 6 and 7 being particularly focused on the bit handling and workflow to achieve the simultaneous processing of the cosine and sin operations.

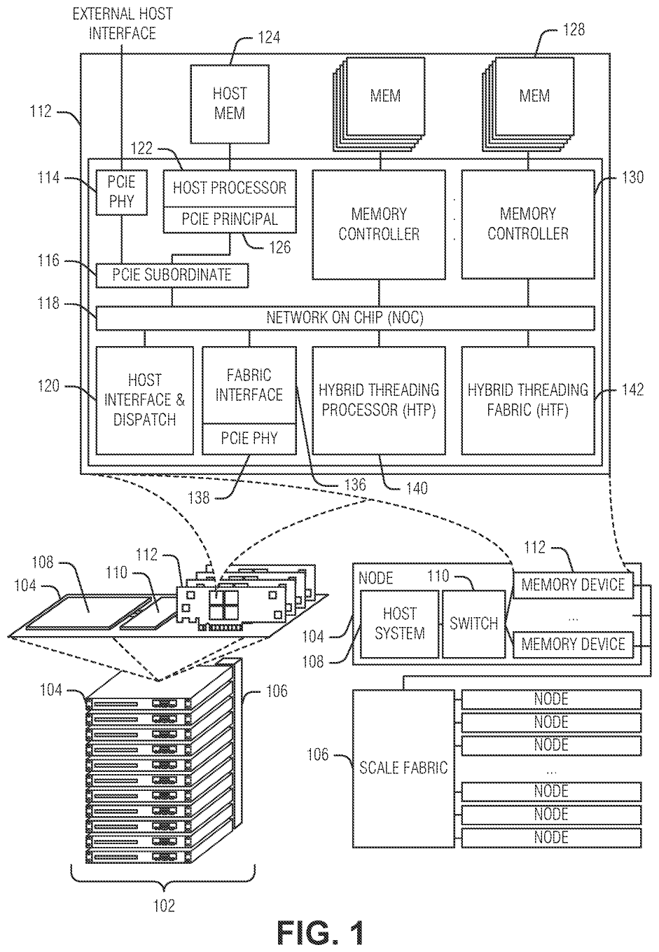

FIG. 1 illustrates generally a first example of a compute-near-memory system, or CNM system 102. The example of the CNM system 102 includes multiple different memory-compute nodes, such as can each include various compute-near-memory devices. Each node in the system can operate in its own operating system (OS) domain (e.g., Linux, among others). In an example, the nodes can exist collectively in a common OS domain of the CNM system 102.

The example of FIG. 1 includes an example of a first memory-compute node 104 of the CNM system 102. The CNM system 102 can have multiple nodes, such as including different instances of the first memory-compute node 104, that are coupled using a scale fabric 106. In an example, the architecture of the CNM system 102 can support scaling with up to n different memory-compute nodes (e.g., n=4096) using the scale fabric 106. As further discussed below, each node in the CNM system 102 can be an assembly of multiple devices.

The CNM system 102 can include a global controller for the various nodes in the system, or a particular memory-compute node in the system can optionally serve as a host or controller to one or multiple other memory-compute nodes in the same system. The various nodes in the CNM system 102 can thus be similarly or differently configured.

In an example, each node in the CNM system 102 can comprise a host system that uses a specified operating system. The operating system can be common or different among the various nodes in the CNM system 102. In the example of FIG. 1, the first memory-compute node 104 comprises a host system 108, a first switch 110, and a first memory-compute device 112. The host system 108 can comprise a processor, such as can include an X86, ARM, RISC-V, or other type of processor. The first switch 110 can be configured to facilitate communication between or among devices of the first memory-compute node 104 or of the CNM system 102, such as using a specialized or other communication protocol, generally referred to herein as a chip-to-chip protocol interface (CTCPI). That is, the CTCPI can include a specialized interface that is unique to the CNM system 102, or can include or use other interfaces such as the compute express link (CXL) interface, the peripheral component interconnect express (PCIe) interface, or the chiplet protocol interface (CPI), among others. The first switch 110 can include a switch configured to use the CTCPI. For example, the first switch 110 can include a CXL switch, a PCIe switch, a CPI switch, or other type of switch. In an example, the first switch 110 can be configured to couple differently configured endpoints. For example, the first switch 110 can be configured to convert packet formats, such as between PCIe and CPI formats, among others.

The CNM system 102 is described herein in various example configurations, such as comprising a system of nodes, and each node can comprise various chips a processor, a switch, a memory device, etc.). In an example, the first memory-compute node 104 in the CNM system 102 can include various chips implemented using chiplets. In the below-discussed chiplet-based configuration of the CNM system 102, inter-chiplet communications, as well as additional communications within the system, can use a CPI network. The CPI network described herein is an example of the CTCPI, that is, as a chiplet-specific implementation of the CTCPI. As a result, the below-described structure, operations, and functionality of CPI can apply equally to structures, operations, and functions as may be otherwise implemented using non-chiplet-based CTCPI implementations. Unless expressly indicated otherwise, any discussion herein of CPI applies equally to CTCPI.

A CPI interface includes a packet-based network that supports virtual channels to enable a flexible and high-speed interaction between chiplets, such as can comprise portions of the first memory-compute node 104 or the CNM system 102. The CPI can enable bridging from intra-chiplet networks to a broader chiplet network. For example, the Advanced eXtensible Interface (AXI) is a specification for intra-chip communications. AXI specifications, however, cover a variety of physical design options, such as the number of physical channels, signal timing, power, etc. Within a single chip, these options are generally selected to meet design goals, such as power consumption, speed, etc. However, to achieve the flexibility of a chiplet-based memory-compute system, an adapter, such as using CPI, can interface between the various AXI design options that can be implemented in the various chiplets. By enabling a physical channel-to-virtual channel mapping and encapsulating time-based signaling with a packetized protocol, CPI can be used to bridge intra-chiplet networks, such as within a particular memory-compute node, across a broader chiplet network, such as across the first memory-compute node 104 or across the CNM system 102.

The CNM system 102 is scalable to include multiple-node configurations. That is, multiple different instances of the first memory-compute node 104, or of other differently configured memory-compute nodes, can be coupled using the scale fabric 106, to provide a scaled system. Each of the memory-compute nodes can run its own operating system and can be configured to jointly coordinate system-wide resource usage.

In the example of FIG. 1, the first switch 110 of the first memory-compute node 104 is coupled to the scale fabric 106. The scale fabric 106 can provide a switch (e.g., a CTCPI switch, a PCIe switch, a CPI switch, or other switch) that can facilitate communication among and between different memory-compute nodes. In an example, the scale fabric 106 can help various nodes communicate in a partitioned global address space (PGAS).

In an example, the first switch 110 from the first memory-compute node 104 is coupled to one or multiple different memory-compute devices, such as including the first memory-compute device 112. The first memory-compute device 112 can comprise a chiplet-based architecture referred to herein as a compute-near-memory (CNM) chiplet. A packaged version of the first memory-compute device 112 can include, for example, one or multiple CNM chiplets. The chiplets can be communicatively coupled using CTCPI for high bandwidth and low latency.

In the example of FIG. 1, the first memory-compute device 112 can include a network on chip (NOC) or first NOC 118. Generally, a NOC is an interconnection network within a device, connecting a particular set of endpoints. In FIG. 1, the first NOC 118 can provide communications and connectivity between the various memory, compute resources, and ports of the first memory-compute device 112.

In an example, the first NOC 118 can comprise a folded Clos topology, such as within each instance of a memory-compute device, or as a mesh that couples multiple memory-compute devices in a node. The Clos topology, such as can use multiple, smaller radix crossbars to provide functionality associated with a higher radix crossbar topology, offers various benefits. For example, the Clos topology can exhibit consistent latency and bisection bandwidth across the NOC.

The first NOC 118 can include various distinct switch types including hub switches, edge switches, and endpoint switches. Each of the switches can be constructed as crossbars that provide substantially uniform latency and bandwidth between input and output nodes. In an example, the endpoint switches and the edge switches can include two separate crossbars, one for traffic headed to the hub switches, and the other for traffic headed away from the hub switches. The hub switches can be constructed as a single crossbar that switches all inputs to all outputs.

In an example, the hub switches can have multiple ports each (e.g., four or six ports each), such as depending on whether the particular hub switch participates in inter-chip communications. A number of hub switches that participates in inter-chip communications can be set by an inter-chip bandwidth requirement.

The first NOC 118 can support various payloads (e.g., from 8 to 64-byte payloads; other payload sizes can similarly be used) between compute elements and memory. In an example, the first NOC 118 can be optimized for relatively smaller payloads (e.g., 8-16 bytes) to efficiently handle access to sparse data structures.

In an example, the first NOC 118 can be coupled to an external host via a first physical-layer interface 114, a PCIe subordinate module 116 or endpoint, and a PCIe principal module 126 or root port. That is, the first physical-layer interface 114 can include an interface to allow an external host processor to be coupled to the first memory-compute device 112. An external host processor can optionally be coupled to one or multiple different memory-compute devices, such as using a PCIe switch or other, native protocol switch. Communication with the external host processor through a PCIe-based switch can limit device-to-device communication to that supported by the switch. Communication through a memory-compute device-native protocol switch such as using CTCPI, in contrast, can allow for more full communication between or among different memory-compute devices, including support for a partitioned global address space, such as for creating threads of work and sending events.

In an example, the CTCPI protocol can be used by the first NOC 118 in the first memory-compute device 112, and the first switch 110 can include a CTCPI switch. The CTCPI switch can allow CTCPI packets to be transferred from a source memory-compute device, such as the first memory-compute device 112, to a different, destination memory-compute device (e.g., on the same or other node), such as without being converted to another packet format.

In an example, the first memory-compute device 112 can include an internal host processor 122. The internal host processor 122 can be configured to communicate with the first NOC 118 or other components or modules of the first memory-compute device 112, for example, using the internal PCIe principal module 126, which can help eliminate a physical layer that would consume time and energy. In an example, the internal host processor 122 can be based on a RISC-V ISA processor, and can use the first physical-layer interface 114 to communicate outside of the first memory-compute device 112, such as to other storage, networking, or other peripherals to the first memory-compute device 112. The internal host processor 122 can control the first memory-compute device 112 and can act as a proxy for operating system-related functionality. The internal host processor 122 can include a relatively small number of processing cores (e.g., 2-4 cores) and a host memory device 124 (e.g., comprising a DRAM module).

In an example, the internal host processor 122 can include PCI root ports. When the internal host processor 122 is in use, then one of its root ports can be connected to the PCIe subordinate module 116. Another of the root ports of the internal host processor 122 can be connected to the first physical-layer interface 114, such as to provide communication with external PCI peripherals. When the internal host processor 122 is disabled, then the PCIe subordinate module 116 can be coupled to the first physical-layer interface 114 to allow an external host processor to communicate with the first NOC 118. In an example of a system with multiple memory-compute devices, the first memory-compute device 112 can be configured to act as a system host or controller. In this example, the internal host processor 122 can be in use, and other instances of internal host processors in the respective other memory-compute devices can be disabled.

The internal host processor 122 can be configured at power-up of the first memory-compute device 112, such as to allow the host to initialize. In an example, the internal host processor 122 and its associated data paths (e.g., including the first physical-layer interface 114, the PCIe subordinate module 116, etc.) can be configured from input pins to the first memory-compute device 112. One or more of the pins can be used to enable or disable the internal host processor 122 and configure the PCI (or other) data paths accordingly.

In an example, the first NOC 118 can be coupled to the scale fabric 106 via a scale fabric interface module 136 and a second physical-layer interface 138. The scale fabric interface module 136, or SIF, can facilitate communication between the first memory-compute device 112 and a device space, such as a partitioned global address space (PGAS). The PGAS can be configured such that a particular memory-compute device, such as the first memory-compute device 112, can access memory or other resources on a different memory-compute device (e.g., on the same or different node), such as using a load/store paradigm. Various scalable fabric technologies can be used, including CTCPI, CPI, Gen-Z, PCI, or Ethernet bridged over CXL. The scale fabric 106 can be configured to support various packet formats. In an example, the scale fabric 106 supports orderless packet communications, or supports ordered packets such as can use a path identifier to spread bandwidth across multiple equivalent paths. The scale fabric 106 can generally support remote operations such as remote memory read, write, and other built-in atomics, remote memory atomics, remote memory-compute device send events, and remote memory-compute device call and return operations.

In an example, the first NOC 118 can be coupled to one or multiple different memory modules, such as including a first memory device 128. The first memory device 128 can include various kinds of memory devices, for example, LPDDR5 or GDDR6, among others. In the example of FIG. 1, the first NOC 118 can coordinate communications with the first memory device 128 via a memory controller 130 that can be dedicated to the particular memory module. In an example, the memory controller 130 can include a memory module cache and an atomic operations module. The atomic operations module can be configured to provide relatively high-throughput atomic operators, such as including integer and floating-point operators. The atomic operations module can be configured to apply its operators to data within the memory module cache (e.g., comprising SRAM memory side cache), thereby allowing back-to-back atomic operations using the same memory location, with minimal throughput degradation.

The memory module cache can provide storage for frequently accessed memory locations, such as without having to re-access the first memory device 128. In an example, the memory module cache can be configured to cache data only for a particular instance of the memory controller 130. In an example, the memory controller 130 includes a DRAM controller configured to interface with the first memory device 128, such as including DRAM devices. The memory controller 130 can provide access scheduling and bit error management, among other functions.

In an example, the first NOC 118 can be coupled to a hybrid threading processor (HTP 140), a hybrid threading fabric (HTF 142) and a host interface and dispatch module (HIF 120). The HIF 120 can be configured to facilitate access to host-based command request queues and response queues. In an example, the HIF 120 can dispatch new threads of execution on processor or compute elements of the HTP 140 or the HTF 142. In an example, the HIF 120 can be configured to maintain workload balance across the HTP 140 module and the HTF 142 module.

The hybrid threading processor, or HTP 140, can include an accelerator, such as can be based on a RISC-V instruction set. The HTP 140 can include a highly threaded, event-driven processor in which threads can be executed in single instruction rotation, such as to maintain high instruction throughput. The HTP 140 comprises relatively few custom instructions to support low-overhead threading capabilities, event send/receive, and shared memory atomic operators.

The hybrid threading fabric, or HTF 142, can include an accelerator, such as can include a non-von Neumann, coarse-grained, reconfigurable processor. The HTF 142 can be optimized for high-level language operations and data types (e.g., integer or floating point). In an example, the HTF 142 can support data flow computing. The HTF 142 can be configured to use substantially all of the memory bandwidth available on the first memory-compute device 112, such as when executing memory-bound compute kernels.

The HTP and HTF accelerators of the CNM system 102 can be programmed using various high-level, structured programming languages. For example, the HTP and HTF accelerators can be programmed using C/C++, such as using the LLVM compiler framework. The HTP accelerator can leverage an open source compiler environment, such as with various added custom instruction sets configured to improve memory access efficiency, provide a message passing mechanism, and manage events, among other things. In an example, the HTF accelerator can be designed to enable programming of the HTF 142 using a high-level programming language, and the compiler can generate a simulator configuration file or a binary file that runs on the HTF 142 hardware. The HTF 142 can provide a mid-level language for expressing algorithms precisely and concisely, while hiding configuration details of the HTF accelerator itself. In an example, the HTF accelerator tool chain can use an LLVM front-end compiler and the LLVM intermediate representation (IR) to interface with an HTF accelerator back end.

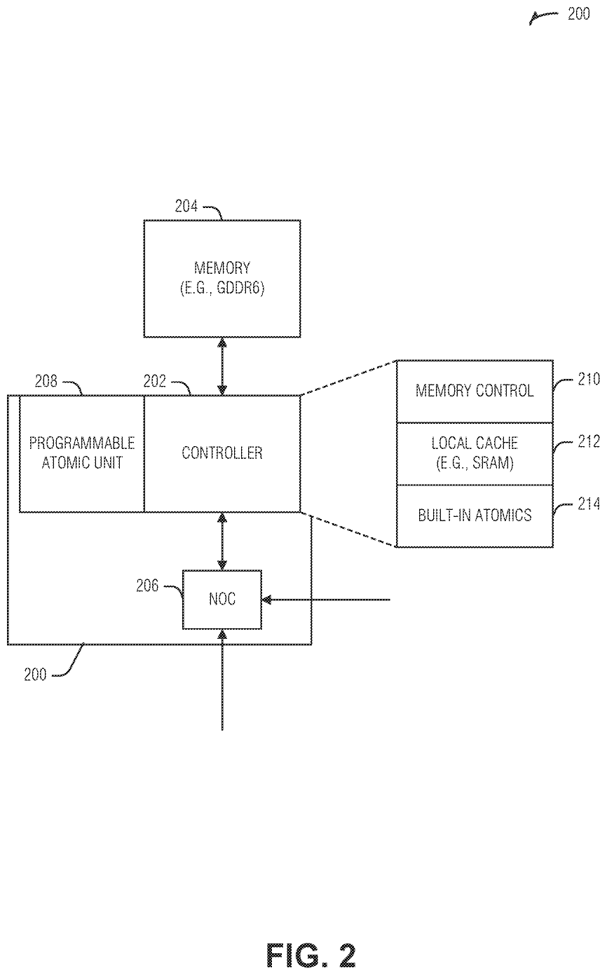

FIG. 2 illustrates generally an example of a memory subsystem 200 of a memory-compute device, according to an embodiment. The example of the memory subsystem 200 includes a controller 202, a programmable atomic unit 208, and a second NOC 206. The controller 202 can include or use the programmable atomic unit 208 to carry out operations using information in a memory device 204. In an example, the memory subsystem 200 comprises a portion of the first memory-compute device 112 from the example of FIG. 1, such as including portions of the first NOC 118 or of the memory controller 130.

In the example of FIG. 2, the second NOC 206 is coupled to the controller 202 and the controller 202 can include a memory control module 210, a local cache module 212, and a built-in atomics module 214. In an example, the built-in atomics module 214 can be configured to handle relatively simple, single-cycle, integer atomics. The built-in atomics module 214 can perform atomics at the same throughput as, for example, normal memory read or write operations. In an example, an atomic memory operation can include a combination of storing data to the memory, performing an atomic memory operation, and then responding with load data from the memory.

The local cache module 212, such as can include an SRAM cache, can be provided to help reduce latency for repetitively-accessed memory locations. In an example, the local cache module 212 can provide a read buffer for sub-memory line accesses. The local cache module 212 can be particularly beneficial for compute elements that have relatively small or no data caches.

The memory control module 210, such as can include a DRAM controller, can provide low-level request buffering and scheduling, such as to provide efficient access to the memory device 204, such as can include a DRAM device. In an example, the memory device 204 can include or use a GDDR6 DRAM device, such as having 16 Gb density and 64 Gb/sec peak bandwidth. Other devices can similarly be used.

In an example, the programmable atomic unit 208 can comprise single-cycle or multiple-cycle operator such as can be configured to perform integer addition or more complicated multiple-instruction operations such as bloom filter insert. In an example, the programmable atomic unit 208 can be configured to perform load and store-to-memory operations. The programmable atomic unit 208 can be configured to leverage the RISC-V ISA with a set of specialized instructions to facilitate interactions with the controller 202 to atomically perform user-defined operations.

Programmable atomic requests, such as received from an on-node or off-node host, can be routed to the programmable atomic unit 208 via the second NOC 206 and the controller 202. In an example, custom atomic operations (e.g., carried out by the programmable atomic unit 208) can be identical to built-in atomic operations (e.g., carried out by the built-in atomics module 214) except that a programmable atomic operation can be defined or programmed by the user rather than the system architect. In an example, programmable atomic request packets can be sent through the second NOC 206 to the controller 202, and the controller 202 can identify the request as a custom atomic. The controller 202 can then forward the identified request to the programmable atomic unit 208.

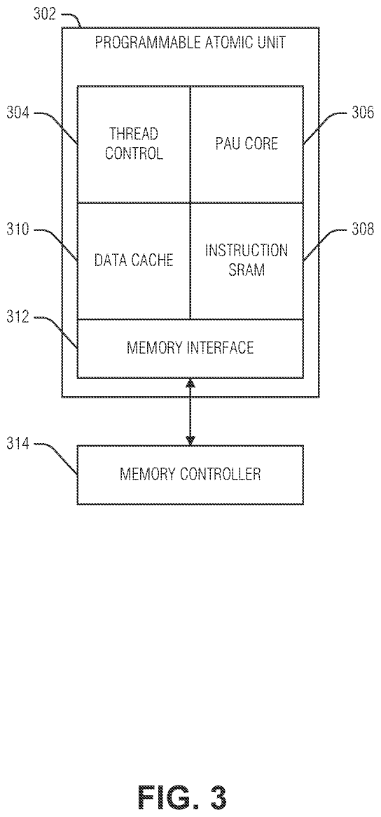

FIG. 3 illustrates generally an example of a programmable atomic unit 302 for use with a memory controller, according to an embodiment. In an example, the programmable atomic unit 302 can comprise or correspond to the programmable atomic unit 208 from the example of FIG. 2. That is, FIG. 3 illustrates components in an example of a programmable atomic unit 302 (PAU), such as those noted above with respect to FIG. 2 (e.g., in the programmable atomic unit 208), or to FIG. 1 (e.g., in an atomic operations module of the memory controller 130). As illustrated in FIG. 3, the programmable atomic unit 302 includes a PAU processor or PAU core 306, a PAU thread control 304, an instruction SRAM 308, a data cache 310, and a memory interface 312 to interface with the memory controller 314. In an example, the memory controller 314 comprises an example of the controller 202 from the example of FIG. 2.

In an example, the PAU core 306 is a pipelined processor such that multiple stages of different instructions are executed together per clock cycle. The PAU core 306 can include a barrel-multithreaded processor, with thread control 304 circuitry to switch between different register files (e.g., sets of registers containing current processing state) upon each clock cycle. This enables efficient context switching between currently executing threads. In an example, the PAU core 306 supports eight threads, resulting in eight register files. In an example, some or all of the register files are not integrated into the PAU core 306, but rather reside in a local data cache 310 or the instruction SRAM 308. This reduces circuit complexity in the PAU core 306 by eliminating the traditional flip-flops used for registers in such memories.

The local PAU memory can include instruction SRAM 308, such as can include instructions for various atomics. The instructions comprise sets of instructions to support various application-loaded atomic operators. When an atomic operator is requested, such as by an application chiplet, a set of instructions corresponding to the atomic operator are executed by the PAU core 306. In an example, the instruction SRAM 308 can be partitioned to establish the sets of instructions. In this example, the specific programmable atomic operator being requested by a requesting process can identify the programmable atomic operator by the partition number. The partition number can be established when the programmable atomic operator is registered with (e.g., loaded onto) the programmable atomic unit 302. Other metadata for the programmable instructions can be stored in memory (e.g., in partition tables) in memory local to the programmable atomic unit 302.

In an example, atomic operators manipulate the data cache 310, which is generally synchronized (e.g., flushed) when a thread for an atomic operator completes. Thus, aside from initial loading from the external memory, such as from the memory controller 314, latency can be reduced for most memory operations during execution of a programmable atomic operator thread.

A pipelined processor, such as the PAU core 306, can experience an issue when an executing thread attempts to issue a memory request if an underlying hazard condition would prevent such a request. Here, the memory request is to retrieve data from the memory controller 314, whether it be from a cache on the memory controller 314 or off-die memory. To resolve this issue, the PAU core 306 is configured to deny the memory request for a thread. Generally, the PAU core 306 or the thread control 304 can include circuitry to enable one or more thread rescheduling points in the pipeline. Here, the denial occurs at a point in the pipeline that is beyond (e.g., after) these thread rescheduling points. In an example, the hazard occurred beyond the rescheduling point. Here, a preceding instruction in the thread created the hazard after the memory request instruction passed the last thread rescheduling point prior to the pipeline stage in which the memory request could be made.

In an example, to deny the memory request, the PAU core 306 is configured to determine (e.g., detect) that there is a hazard on memory indicated in the memory request. Here, hazard denotes any condition such that allowing (e.g., performing) the memory request will result in an inconsistent state for the thread. In an example, the hazard is an in-flight memory request. Here, whether or not the data cache 310 includes data for the requested memory address, the presence of the in-flight memory request makes it uncertain what the data in the data cache 310 at that address should be. Thus, the thread must wait for the in-flight memory request to be completed to operate on current data. The hazard is cleared when the memory request completes.

In an example, the hazard is a dirty cache line in the data cache 310 for the requested memory address. Although the dirty cache line generally indicates that the data in the cache is current and the memory controller version of this data is not, an issue can arise on thread instructions that do not operate from the cache. An example of such an instruction uses a built-in atomic operator, or other separate hardware block, of the memory controller 314. In the context of a memory controller, the built-in atomic operators can be separate from the programmable atomic unit 302 and do not have access to the data cache 310 or instruction SRAM 308 inside the PAU. If the cache line is dirty, then the built-in atomic operator will not be operating on the most current data until the data cache 310 is flushed to synchronize the cache and the other or off-die memories. This same situation could occur with other hardware blocks of the memory controller, such as cryptography block, encoder, etc.

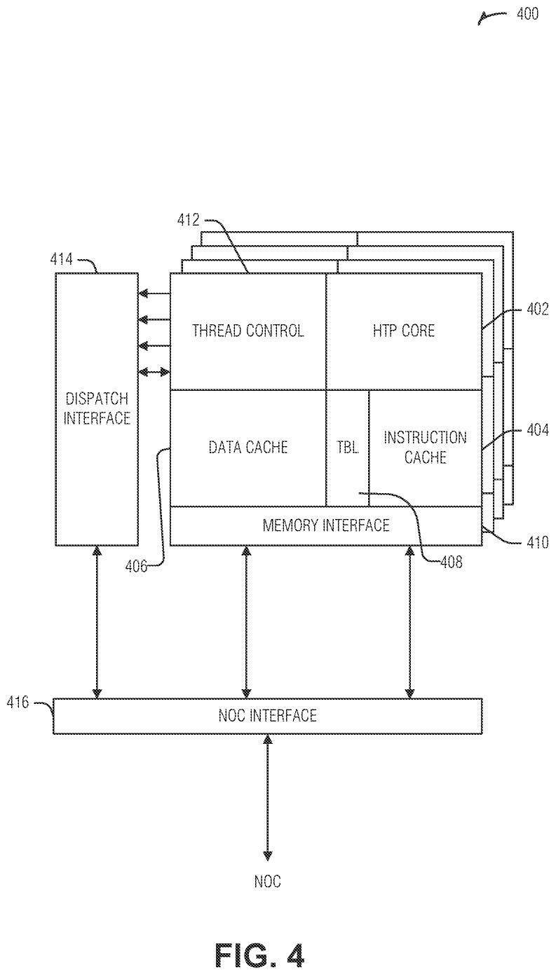

FIG. 4 illustrates an example of a hybrid threading processor (HTP) accelerator, or HTP accelerator 400. The HTP accelerator 400 can comprise a portion of a memory-compute device, according to an embodiment. In an example, the HTP accelerator 400 can include or comprise the HTP 140 from the example of FIG. 1. The HTP accelerator 400 includes, for example, a HTP core 402, an instruction cache 404, a data cache 406, a translation block 408, a memory interface 410, and a thread controller 412. The HTP accelerator 400 can further include a dispatch interface 414 and a NOC interface 416, such as for interfacing with a NOC such as the first NOC 118 from the example of FIG. 1, the second NOC 206 from the example of FIG. 2, or other NOC.

In an example, the HTP accelerator 400 includes a module that is based on a RISC-V instruction set, and can include a relatively small number of other or additional custom instructions to support a low-overhead, threading-capable Hybrid Threading (HT) language. The HTP accelerator 400 can include a highly-threaded processor core, the HTP core 402, in which, or with which, threads can be executed in a single instruction rotation, such as to maintain high instruction throughput. In an example, a thread can be paused when it waits for other, pending events to complete. This can allow the compute resources to be efficiently used on relevant work instead of polling. In an example, multiple-thread barrier synchronization can use efficient HTP-to-HTP and HTP-to/from-Host messaging, such as can allow thousands of threads to initialize or wake in, for example, tens of clock cycles.

In an example, the dispatch interface 414 can comprise a functional block of the HTP accelerator 400 for handling hardware-based thread management. That is, the dispatch interface 414 can manage dispatch of work to the HTP core 402 or other accelerators. Non-HTP accelerators, however, are generally not able to dispatch work. In an example, work dispatched from a host can use dispatch queues that reside in, e.g., host main memory (e.g., DRAM-based memory). Work dispatched from the HTP accelerator 400, on the other hand, can use dispatch queues that reside in SRAM, such as within the dispatches for the target HTP accelerator 400 within a particular node.

In an example, the HTP core 402 can comprise one or more cores that execute instructions on behalf of threads. That is, the HTP core 402 can include an instruction processing block. The HTP core 402 can further include, or can be coupled to, the thread controller 412. The thread controller 412 can provide thread control and state for each active thread within the HTP core 402. The data cache 406 can include cache for a host processor (e.g., for local and remote memory-compute devices, including for the HTP core 402), and the instruction cache 404 can include cache for use by the HTP core 402. In an example, the data cache 406 can be configured for read and write operations, and the instruction cache 404 can be configured for read only operations.

In an example, the data cache 406 is a small cache provided per hardware thread. The data cache 406 can temporarily store data for use by the owning thread. The data cache 406 can be managed by hardware or software in the HTP accelerator 400. For example, hardware can be configured to automatically allocate or evict lines as needed, as load and store operations are executed by the HTP core 402. Software, such as using RISC-V instructions, can determine which memory accesses should be cached, and when lines should be invalidated or written back to other memory locations.

Data caching on the HTP accelerator 400 has various benefits, including making larger accesses more efficient for the memory controller, allowing an executing thread to avoid stalling. However, there are situations when using the cache causes inefficiencies. An example includes accesses where data is accessed only once, and causes thrashing of the cache lines. To help address this problem, the HTP accelerator 400 can use a set of custom load instructions to force a load instruction to check for a cache hit, and on a cache miss to issue a memory request for the requested operand and not put the obtained data in the data cache 406. The HTP accelerator 400 thus includes various different types of load instructions, including non-cached and cache line loads. The non-cached load instructions use the cached data if dirty data is present in the cache. The non-cached load instructions ignore clean data in the cache, and do not write accessed data to the data cache. For cache line load instructions, the complete data cache line (e.g., comprising 64 bytes) can be loaded from memory into the data cache 406, and can load the addressed memory into a specified register. These loads can use the cached data if clean or dirty data is in the data cache 406. If the referenced memory location is not in the data cache 406, then the entire cache line can be accessed from memory. Use of the cache line load instructions can reduce cache misses when sequential memory locations are being referenced (such as memory copy operations) but can also waste memory and bandwidth at the NOC interface 416 if the referenced memory data is not used.

In an example, the HTP accelerator 400 includes a custom store instruction that is non-cached. The non-cached store instruction can help avoid thrashing the data cache 406 with write data that is not sequentially written to memory.

In an example, the HTP accelerator 400 further includes a translation block 408. The translation block 408 can include a virtual-to-physical translation block for local memory of a memory-compute device. For example, a host processor, such as in the HTP core 402, can execute a load or store instruction, and the instruction can generate a virtual address. The virtual address can be translated to a physical address of the host processor, such as using a translation table from the translation block 408. The memory interface 410, for example, can include an interface between the HTP core 402 and the NCC′ interface 416.

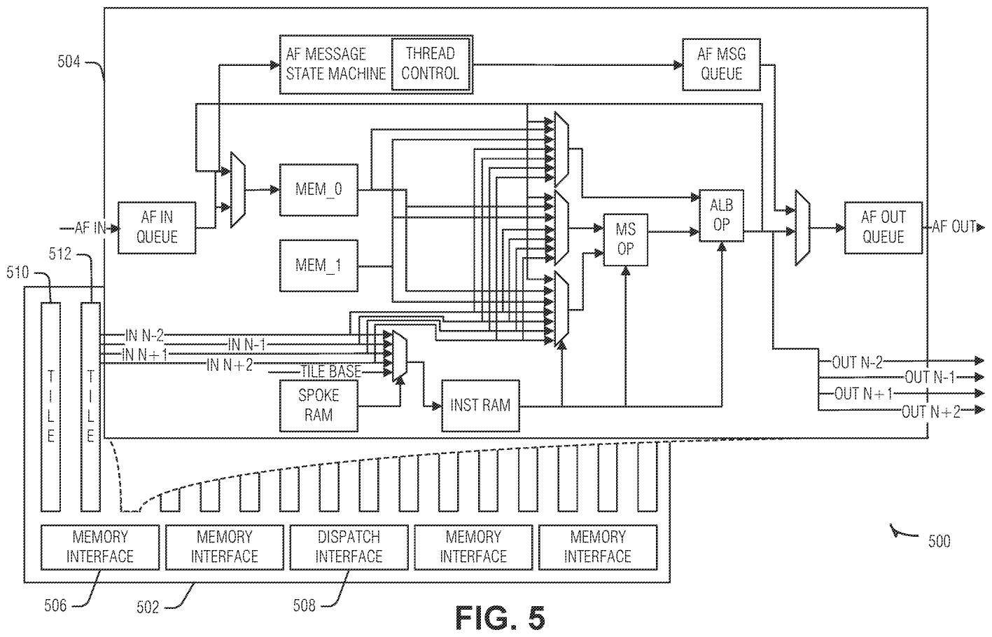

FIG. 5 illustrates an example of a representation of a hybrid threading fabric (HTF), or HTF 500, of a memory-compute device, according to an embodiment. In an example, the HTF 500 can include or comprise the HTF 142 from the example of FIG. 1. The HTF 500 is a coarse-grained, reconfigurable compute fabric that can be optimized for high-level language operand types and operators (e.g., using C/C++ or other high-level language). In an example, the HTF 500 can include configurable, n-bit wide (e.g., 512-bit wide) data paths that interconnect hardened SIMD arithmetic units.

In an example, the HTF 500 comprises an HTF cluster 502 that includes multiple HTF tiles, including an example tile 504, or Tile N. Each HTF tile can include one or more compute elements with local memory and arithmetic functions. For example, each tile can include a compute pipeline with support for integer and floating-point operations. In an example, the data path, compute elements, and other infrastructure can be implemented as hardened IP to provide maximum performance while minimizing power consumption and reconfiguration time.

In the example of FIG. 5, the tiles comprising the HTF cluster 502 are linearly arranged, and each tile in the cluster can be coupled to one or multiple other tiles in the HTF cluster 502. In the example of FIG. 5, the example tile 504, or Tile N, is coupled to four other tiles, including to a base tile 510 (e.g., Tile N-2) via the port labeled SF IN N-2, to an adjacent tile 512 (e.g., Tile N−1) via the port labeled SF IN N−1, and to a Tile N+1 via the port labeled SF IN N+1 and to a Tile N+2 via the port labeled SF IN N+2. The example tile 504 can be coupled to the same or other tiles via respective output ports, such as those labeled SF OUT N−1, SF OUT N−2, SF OUT N+1, and SF OUT N+2. In this example, the ordered list of names for the various tiles are notional indications of the positions of the tiles. In other examples, the tiles comprising the HTF cluster 502 can be arranged in a grid or other configuration, with each tile similarly coupled to one or several of its nearest neighbors in the grid. Tiles that are provided at an edge of a cluster can optionally have fewer connections to neighboring tiles. For example, Tile N-2, or the base tile 510 in the example of FIG. 5, can be coupled only to the adjacent tile 512 (Tile N-1) and to the example tile 504 (Tile N). Fewer or additional inter-tile connections can similarly be used. The connections (e.g., with ports as interfaces at any given tile) can be referred to as lanes. In an example, a lane has a width of sixty-four bits.

The HTF cluster 502 can further include memory interface modules, including a first memory interface module 506. The memory interface modules can couple the HTF cluster 502 to a NOC, such as the first NOC 118. In an example, the memory interface modules can allow tiles within a cluster to make requests to other locations in a memory-compute system, such as in the same or different node in the system. That is, the representation of the HTF 500 can comprise a portion of a larger fabric that can be distributed across multiple nodes, such as with one or more HTF tiles or HTF clusters at each of the nodes. Requests can be made between tiles or nodes within the context of the larger fabric.

In the example of FIG. 5, the tiles in the HTF cluster 502 are coupled using a synchronous fabric (SF). The synchronous fabric can provide communication between a particular tile and its neighboring tiles in the HTF cluster 502, as described above. Each HTF cluster 502 can further include an asynchronous fabric (AF) that can provide communication among, e.g., the tiles in the cluster, the memory interfaces in the cluster, and a dispatch interface 508 in the cluster.

In an example, the synchronous fabric can exchange messages that include data and control information. The control information can include, among other things, instruction RAM address information or a thread identifier. The control information can be used to set up a data path, and a data message field can be selected as a source for the path, Generally, the control fields can be provided or received earlier, such that they can be used to configure the data path. For example, to help minimize any delay through the synchronous domain pipeline in a tile, the control information can arrive at a tile a few clock cycles before the data field. Various registers can be provided to help coordinate dataflow timing in the pipeline.

In an example, each tile in the HTF cluster 502 can include multiple memories. Each memory can have the same width as the data path (e.g., 512 bits) and can have a specified depth, such as in a range of 512 to 1024 elements. The tile memories can be used to store data that supports data path operations. The stored data can include constants loaded as part of a kernel's cluster configuration, for example, or can include variables calculated as part of the data flow. In an example, the tile memories can be written from the asynchronous fabric as a data transfer from another synchronous domain, or can include a result of a load operation such as initiated by another synchronous domain. The tile memory can be read via synchronous data path instruction execution in the synchronous domain.

In an example, each the in an HTF duster 502 can have a dedicated instruction RAM (INST RAM). In an example of an HTF duster 502 with sixteen tiles, and instruction RAM instances with sixty-four entries, the duster can allow algorithms to be mapped with up to 1024 multiply-shift and/or ALU operations. The various tiles can optionally be pipelined together, such as using the synchronous fabric, to allow data flow compute with minimal memory access, thus minimizing latency and reducing power consumption. In an example, the asynchronous fabric can allow memory references to proceed in parallel with computation, thereby providing more efficient streaming kernels. In an example, the various tiles can include built-in support for loop-based constructs and can support nested looping kernels.

The synchronous fabric can allow multiple tiles to be pipelined, such as without a need for data queuing. Tiles that participate in a synchronous domain can, for example, act as a single pipelined data path. A first or base tile (e.g., Tile N-2, in the example of FIG. 5) of a synchronous domain can initiate a thread of work through the pipelined tiles. The base tile can be responsible for starting work on a predefined cadence referred to herein as a Spoke Count. For example, if the Spoke Count is 3, then the base tile can initiate work every third clock cycle.

In an example, the synchronous domain comprises a set of connected tiles in the HTF cluster 502. Execution of a thread can begin at the domain's base tile and can progress from the base tile, via the synchronous fabric, to other tiles in the same domain. The base tile can provide the instruction to be executed for the first tile. The first tile can, by default, provide the same instruction for the other connected tiles to execute. However, in some examples, the base tile, or a subsequent tile, can conditionally specify or use an alternative instruction. The alternative instruction can be chosen by having the tile's data path produce a Boolean conditional value, and then can use the Boolean value to choose between an instruction set of the current tile and the alternate instruction.

The asynchronous fabric can be used to perform operations that occur asynchronously relative to a synchronous domain, Each tile in the HTF cluster 502 can include an interface to the asynchronous fabric. The inbound interface can include, for example, a FIFO buffer or queue (e.g., AF IN QUEUE) to provide storage for message that cannot be immediately processed. Similarly, the outbound interface of the asynchronous fabric can include a FIFO buffer or queue (e.g., AF OUT QUEUE) to provide storage for messages that cannot be immediately sent out.

In an example, messages in the asynchronous fabric can be classified as data messages or control messages. Data messages can include a SIMD width data value that is written to either tile memory 0 (MEM_0) or memory 1 (MEM_1). Control messages can be configured to control thread creation, to free resources, or to issue external memory references.

A tile in the HTF cluster 502 can perform various compute operations for the HTF. The compute operations can be performed by configuring the data path within the tile. In an example, a tile includes two functional blocks that perform the compute operations for the tile: a Multiply and Shift Operation block (MS OP) and an Arithmetic, Logical, and Bit Operation block (ALB OP). The two blocks can be configured to perform pipelined operations such as a Multiply and Add, or a Shift and Add, among others.

In an example, each instance of a memory-compute device in a system can have a complete supported instruction set for its operator blocks (e.g., MS OP and ALB OP). In this case, binary compatibility can be realized across all devices in the system. However, in some examples, it can be helpful to maintain a base set of functionality and optional instruction set classes, such as to meet various design tradeoffs, such as die size. The approach can be similar to how the RISC-V instruction set has a base set and multiple optional instruction subsets.

In an example, the example tile 504 can include a Spoke RAM. The Spoke RAM can be used to specify which input (e.g., from among the four SF tile inputs and the base tile input) the primary input for each clock cycle. The Spoke RAM read address input can originate at a counter that counts from zero to Spoke Count minus one. In an example, different spoke counts can be used on different tiles, such as within the same HTF cluster 502, to allow a number of slices, or unique tile instances, used by an inner loop to determine the performance of a particular application or instruction set. In an example, the Spoke RAM can specify when a synchronous input is to be written to a tile memory, for instance when multiple inputs for a particular the instruction are used and one of the inputs arrives before the others. The early-arriving input can be written to the tile memory and can be later read when all of the inputs are available. In this example, the tile memory can be accessed as a FIFO memory, and FIFO read and write pointers can be stored in a register-based memory region or structure in the tile memory.

The hardware of the HTF cluster 502 (HTF) or the HTP accelerator 400 (HTP) can be used to implement concurrent sin and cosine performance from a single input value. For clarity, the following hardware is described from the perspective of processing circuitry of the HTF cluster 502, although some or all of the operations can be performed by processing circuitry of the HTP accelerator 400 or other components of a compute-near memory system (such as the CNM system 102).

To perform the concurrent sin and cosine operations, the processing circuitry is configured to obtain (e.g., received or retrieved) a first sequence of bits representing an angle of a line from an origin to a unit circle. The processing circuitry can obtain the sequence of bits from an interface (e.g., a NOC to the HTF or HTP) in a register of the processing circuitry, or from another storage device accessible to the processing circuitry (such as a memory 128). In an example, the processing circuitry is an HTF (e.g., the HTF cluster 502). In this example, the first sequence of bits is obtained from a first lane of the HTF (e.g., a port corresponding to IN N-2) in the tile 504). In an example, the first sequence of bits is sixty-four bits.

The processing circuitry is configured to determine a quadrant of the unit circle for the line. In an example, the processing circuitry includes a hardware block for determining the quadrant. An example of such a hardware block is a special instruction supported by the hardware, such as PTruncLsbsF64FromF64 as described with respect to FIG. 6.

The processing circuitry is configured to replace the two least significant bits (lsbs) of the first sequence of bits with an encoding for the quadrant. The encoding can follow that discussed with respect to FIG. 6, where the two lsbs are 00 for the first quadrant, 01 for the second quadrant, 10 for the third quadrant, and 11 for the fourth quadrant. However, other encodings can be used. In an example, the replacing of the 2 lsbs can be performed by a hardware block of the processing circuitry (e.g., as a special instruction). In an example, the same hardware block used to determine the quadrant performs this operation as well. This value can be referred to with a q to indicate that the quadrant is encoded. Thus, if the first sequence of bits originally represented the angle X, the first sequence of bits now represents Xq, or the quadrant encoded version of the angle K.

The processing circuitry is configured to reduce (e.g., translate) the angle to a base quadrant angle in a second sequence of bits that is a same length as the first sequence of bits. Here, the base quadrant is the one quadrant in which the sin and cosine operations (described below) will operate. As used in the examples of FIG. 6, the first quadrant is the base quadrant, although another quadrant can be used as the base quadrant with appropriate adjustments to the conversion of intermediate sin and cosine solutions to final sin and cosine solutions. In an example, reducing the angle to the base quadrant angle in the second sequence of bits

$$( e . g . , \frac{π}{2} )$$

includes subtracting the encoded quadrant times ninety degrees from the angle to produce a result that is stored in the second sequence of bits. At this point, the result (e.g., the second sequence of bits) can be referred to as Xqr to indicate that the angle has the quadrant encoded and is reduced to the base quadrant. Other operations can also be performed to put the representation of the angle into a better form for subsequent work, such as squaring the base quadrant angle before storing the in the second sequence of bits. Although these examples use the second sequence of bits to store Xqr, the first sequence of bits can be modified to hold Xqr as well. As long as the quadrant encoding is intact, manipulations to the other bits in the first sequence of bits will not affect the ability of the first sequence of bits to communicate the original quadrant when the final solutions are determined.

The processing circuitry is configured to perform sin and cosine operations (e.g., calculations) on a portion of the second sequence of bits to create an intermediate sin solution and an intermediate cosine solution in the base quadrant. Performing all sin and cosine operations in a single quadrant, the base quadrant eliminates branching in the calculations. Thus, the sin and cosine operations can be efficiently performed on CIMD hardware, such as HTF tiles, graphics processing units (GPUs), or other vector architectures. This enables these parallel execution units to further speed the intermediate sin and cosine calculations.

While the entirety of the angle bits in Xqr could be used for the sin and cosine calculations could be used, sixty-two bit resolution is often unnecessary. In fact, thirty-two bit precision is often sufficient. When, for example, the first sequence of bits is sized based on the input interface (e.g., a lane of the HTF), angle precision more than half the input interface reduces parallelism because any given communication window can only transmit the angle value to perform one of the sin or cosine operation. However, if the precision is reduced to half (e.g., thirty-two-bits from sixty four), then the value can be duplicated to inhabit the first half of a communication and the second half of the communication. This, the first thirty-two bits and the second thirty-two bits of the second sequence of bits are the same.

Because the entirety of the available sixty-four bits is used in this example, the first sequence of bits cannot be reused unless the quadrant encoding is maintained elsewhere. The second sequence of bits can be communicated where the sin calculation is performed on one half and the cosine calculation is performed on the second half to create intermediate sin and cosine solutions. These solutions are complete from the perspective of the base quadrant but are intermediate until converted into the original quadrant.

In an example, performing the sin and cosine operations on the portion of the second sequence of bits to create an intermediate sin solution and an intermediate cosine solution in the base quadrant includes converting the second sequence of bits from a higher precision value to a lower precision value—e.g., converting from a double to a float—and storing the lower precision value to a first part of a sixty-four bit value. Then, the lower resolution version (e.g., the float) is also copied to a second part of the sixty-four bit value. Sin operations are performed on one part (e.g., the first half) of the second sequence of bits and cosine operations are performed on another part of the second sequence of bits (e.g., the second half). In an example, an output from the sin operations replaces the first part of the sixty-four bit value and the cosine operations replace the second part of the sixty-four bit value. Here, the first part and the second part respectively refer to the bits upon which the sin operation and the cosine operation were respectively performed. Thus, if the second half of the second sequence of bits were used as input to the sin calculation, then the first part in which the output is stored is the second half of the second sequence of bits.

The processing circuitry is configured to use the encoding for the quadrant in the first sequence of bits on the intermediate sin solution and the intermediate cosine solution to create a final sin solution and a final cosine solution in the quadrant. Thus, the solution in the base quadrant is converted to a solution in the original quadrant of the angle. FIG. 6 illustrates several techniques to perform this conversion. Generally, if the base quadrant is the same as the original quadrant no conversion is necessary, or the intermediate values are equal to the final values. Otherwise, the exchange of the values or changing of a sign will effectuate the conversion and no change in the numerical value occurs. In the example illustrated in FIG. 6, the quadrants are a first quadrant (the base quadrant)—between −45 degrees (e.g., 315 degrees) and 45 degrees, a second quadrant from 45 to 135 degrees, a third quadrant from 135 to 225 degrees, and a fourth quadrant from 225 to 315 degrees. In this context, when the quadrant is the first quadrant—according to the encoding for the quadrant in the first sequence of bits—nothing is changed because this is the base quadrant. Otherwise:
if the quadrant is the second quadrant, the conversion from the intermediate to final solutions are 1. using the intermediate cosine solution as the final sin solution; and 2. the negation of the intermediate sin solution as the final cosine solution, or the final solution is sin X=cos X′ and cos X=−sin X′ using the example from FIG. 6,
If the quadrant is the third quadrant, the conversion from the intermediate to final solutions are 1. using the negation of the intermediate sin solution as the final sin solution; and 2. using the negation of the intermediate cosine solution as the final cosine solution, or sin X=−sin′ and cos X=−cos X′.
If the quadrant is the fourth quadrant, the conversion from the intermediate to final solutions are 1. using the negation of the intermediate cosine solution is used as the final sin solution; and 2. using the intermediate sin solution as the final cosine solution, or sin X=−cos X′ and cos X=sin X′.

In an example, the intermediate sin solution and the intermediate cosine solution are stored within the third sequence of bits. In an example, the processing circuitry includes a hardware block that accepts the first sequence of bits with the quadrant encoded and the second sequence of bits to create the final sin solution and the final cosign solution. An example of this hardware block can include a special purpose instruction, such as NegCF32FromTruncLsbsF64 as described below. Implementing this functionality in the hardware does increase the complexity of the hardware, however, it can eliminate the branching issues that are highly inefficient to SIMD architectures.

In an example, the first sequence of bits is a variable to Euler's formula, the final sin solution is an imaginary part of the solution to Euler's formula with the variable, and the final cosine solution is a real part of the solution to Euler's formula with the variable. As noted above, computing Euler's formula is a constant task in modern signal processing, whether it is processing sensor data, such as images, radar, sound, or radio signals, or driving actuators (e.g., motors), graphic displays, speakers, or radios. Using the techniques described herein enables fast and efficient use of SIMD, and other, architectures to perform Euler's formula and enable these technologies.

FIG. 6 illustrates a unit circle with angle and quadrant relationships to sin and cosine, according to an embodiment. The description above about the concurrent sin and cosine calculations can benefit from the illustration in FIG. 6. Here, a unit circle for real and imaginary parts of a complex circle are illustrated. The unit circle is divided into four quadrants that each span an angle of

$$\frac{π}{2} .$$

The quadrants are labeled by the bits used to represent them when the two least significant bits of the input are replaced with the quadrant encoding. As illustrated, the first quadrant (00) 602 spans from

$$- \frac{π}{4} to \frac{π}{4} ,$$

the second quadrant (01) 604 spans from

$$\frac{π}{4} to \frac{3 π}{4} ,$$

the third quadrant (10) 606 spans from

$$\frac{3 π}{4} to \frac{5 π}{4} ,$$

and the fourth quadrant (11) spans from

$$\frac{5 π}{4} to - \frac{π}{4} .$$

In the illustration, an example of an input (angle X) is provided to illustrate the nature of the manipulations described. Specifically, the angle X is in the third quadrant (10) 606. If the X is translated to the first quadrant (00) 602, represented as X′, it is clear that the sin and cosine calculations on X′ can be translated back to the third quadrant (10) 606 by simply changing the signs of the sin and cosine values. The following expands upon this example.

In an example, the quadrant of the angle X can be determined by finding a value of k such that

$$X - k * \frac{π}{2} = [ - \frac{π}{4} , \frac{π}{4} ] .$$

Once k is found, let the quadrant Q=k mod 4, where “mod” is the modulus operator. Thus, k can start at zero and increment by 1 three or fewer times to find a k that is acceptable. Thus, in the illustrated example, neither

$$X - 0 * \frac{π}{2} , or X - 1 * \frac{π}{2}$$

fall within the range of

$$[ - \frac{π}{4} , \frac{π}{4} ] , but X - 2 * \frac{π}{2}$$

(a 180 degree or retranslation) does place X′ within the first quadrant (00) 602.

The relationship between the sin and cosine solutions in the first quadrant (00) 602 to other quadrants under the translation this translation is provided in the following table:

| Quadrant (k value) | sin X | cos X |
|---|---|---|
| 00 (0) | sin X | cos X |
| 01 (1) | cos X | −sin X |
| 10 (2) | −sin X | −cosX |
| 11 (3) | −cos X | sin X |

Thus, it is possible to perform the sin and cosine operations in the first quadrant (00) 602 to produce intermediate results that can then be adjusted based on the quadrant determination.

For example, to calculate the sin and cosine of X, represented by a sequence of sixty-four bits, the quadrant Q (as illustrated Q=2 or the third quadrant (10) 606) is determined. The least two significant mantissa bits of X are replaced with Q (e.g., 10), converting X (e.g., the sequence of bits representing X) into Xq to indicate that the sequence of bits includes the quadrant. In an example, the hardware implements the instruction PTruncLsbsF64FromF64 (described below) to perform this operation. At this point, the quadrant is determined and encoded into the original input value of X.

X can then be translated to the first quadrant (00) 602 by subtracting

$$k * \frac{π}{2} .$$

This translation can be thought of a reduction of X. Accordingly, Xq is reduced to the range of

$$[ - \frac{π}{4} , \frac{π}{4} ]$$

by subtracting π from X in the illustrated example, to create Xqr (illustrated as X′ Xqr is stored in a second sequence of bits than those to hold Xq as the encoded quadrant in Xq is preserved for additional operations below. In an example, the hardware implements the instruction PMullgnore2lsbs (described below) to perform this operation.

Xqr can then be squared, reduced in size, and duplicated into a single sequence of bits. For example, in a system in which double precision floating point values (e.g., a double) are sixty-four bits, the reduction can include converting the double to a float (e.g., thirty-two bits). Thus, the duplicated value can fit into a single double value. If an HTF lane is a double value, the reduction and duplication enable the angle to be separately communicated (e.g., for separate sin and cosine calculations) to a tile in a single operation. Thus, with the loss of some precision for the angle X, the number of communications to an HTF tile, or to an HTP can be reduced in half. Generally, this is a beneficial tradeoff between performance and accuracy in many applications. Generally, the important aspect in the precision reduction of the angle is the reduction of the angle to the base quadrant and squaring the angle for a Taylor series computation of the sin or cosine. At this point, the precision (e.g., resolution) can be safely reduced without significant effects on the final sin or cosine values. Accordingly, precision is not arbitrarily reduced, but rather reduced at a point in the processing that can tolerate the reduced precision.

Once Xqr is created, standard techniques, such as Taylor series expansions or any other expansion, can be performed to create thirty-two bit sin and cosine values. These values are intermediate, not the final results, because they are performed within the first quadrant (00) 602 and need to be converted into the original quadrant to be complete. These intermediate results can be produced in parallel by tiles in the HTF, an HTP, or other processing circuitry in a CNM system. Further, by performing the computation in a single quadrant, branching is avoided in the parallel processing elements (e.g., SIMM processors or HTF tiles) providing greater efficiency when using these elements.

Once the intermediate results are acquired, the intermediate results are converted to the final results using the table above. In an example, the hardware implements the instruction PNegCF32FromTruncLsbsF64 (described below) to perform this operation.

The following pseudo code—using the hardware special instructions TruncLsbs64F64From64, PMulIgnoreasbs, and NegCF32FromTruncLsbsF64—illustrates the process:

| | |
|---|---|
| double X; | // value to take sin/cosine |

| 1 & 2) Xq = TruncLsbs64F64From64( RoundF64(X* TWO_DIV_PI)); | // determine quadrant |
|---|---|
| | and set // the two least- |
| | significant-bits // (lsbs) to |
| | the quadrant. |

| | |
|---|---|
| 3) fsDMul = PMulIgnore2Lsbs(Xq * PI_DIV_TWO); | // Ignore two lsbs of Xq |
| 4a) fsD = x − fsDMul; | //Translate X to the first |

quadrant

| | |
|---|---|
| 4b) complex g = ( float(fsD * fsD), float(fsD * fsD)); | // Reduce and duplicate (g is |

Xqr

// from above). In the notation
// below, g.im refers to the

imaginary

// half of g (e.g., the first thirty-

two

// bits) upon which sin will be
// calculated and g.re refers to

the

// real half of g (e.g., the second
// thirty-two bits) upon which

cosine

| | //will be calculated. |
|---|---|
| 5a) complex step2 = (fsD, 1.0); | // perform Taylor series |

expansion
5b) complex step3 = (−0.0001984086154f,−0.138885249433e−2f);
5c) complex step4 = (0.008333330973f + step3.re * g.re, 0.416666506699e−1f + step3.im* g.im);
5d) complex step5 = (−0.1666666660f + step4.re * g.re, −0.499999998030f + step4.im *g.im);

| | |
|---|---|
| 5e) complex step6 = (1.0f + step5.re * g.re, 1.0f + step5.im * g.im); | // step6 is the variable |

holding

// intermediate results
for the
// sin and cosine
calculations.

| | |
|---|---|
| 6) complex SC = NegCF32FromTruncLsbsF64(step6, Xq); | // the final results SC is |

produced by

// using the quadrant encoding

from

//Xq to convert the

intermediate

// results

The following are representations to irnplement the special instructions TruncLsbs64F64From64, PMullgnore2Lsbs, and NegCF32FromTruncLsbsF64 in hardware, assuming sixty-four bit doubles and thirty-two bit floats:

```
  PTruncLsbsF64FromF64 can be defined as:
for (int i = 0; i < HTF_PACK_64_CNT; i += 1) {
  alOpOut.m_f64[i] = (int) c1_alIn2.m_f64[i] & ~0x3;
  uint64_t n1 = (int) alOpOut.m_f64[i] & 0x1 LL;
  uint64_t n2 = (int) alOpOut.m_f64[i] & 0x2 LL;
  alOpOut.m_u64[i] | = (n1 | n2);
}
  PMulIgnore2Lsbs can be defined as:
for (int i = 0; i < HTF_PACK_64_CNT; i += 1) {
```

| | |
|---|---|
| msIn1.m_u64[i] &= ~0x3LL; | // Zero out 2 lsbs |

```
  msOpOut.m_f64[i] = msIn1.m_f64[i] * msIn2.m_f64[i];
}
  PNegCF32\grave{ }FromTruncLsbsF64 can be defined as:
// The least significant s 2 bits of op2 specify which quadrant the complex number was
from.
// Use those to selectively negate the Complex
F32 in Op1
for (int i = 0; i < HTF_PACK_64_ CNT; i += 1) {
  bool n1 = (c1_alIn2.m_u64[i] & 0x1 LL) != 0;
  bool n2 = (c1_alIn2.m_u64[i] & 0x2 LL) != 0;
  if (n1) {
```

| | |
|---|---|
| if (n2) { | //Quadrant 11 |
| alOpOut.m_u32[i * 2] = c1_alIn1.m_u32[i * 2] \hat{ } 0x00000000; | // use real |

portion

| | |
|---|---|
| alOpOut.m_u32[i * 2 + 1] = c1_alIn1.m_u32[i * 2 + 1] \hat{ } 0x8000000; | // negate |

imaginary

| | |
|---|---|
| | // portion |
| } else { | // Quadrant 01 |
| alOpOut.m_u32[i * 2] = c1_alIn1.m_u32[i * 2] \hat{ } 0x80000000; | // negate real |

portion

| | |
|---|---|
| alOpOut.m_u32[i * 2 + 1] = c1_alIn1.m_u32[i*2 + 1] \hat{ } 0x00000000; | // use imaginary |
| | // portion |

}

| | |
|---|---|
| uint32_t tmp = alOpOut.m_u32[i * 2]; | // swap the real |
| alOpOut.m_u32[i * 2] = alOpOut.m_u32[i * 2 + 1]; | // portion and the |
| alOpOut.m_u32[i * 2 + 1] = tmp; | // imaginary |

portion
} else {

| | |
|---|---|
| if (n2) { | //Quadrant 10 |
| alOpOut.m_u32[i * 2] = c1_alIn1.m_u32[i * 2] \hat{ } 0x80000000; | // negate real |

portion

| | |
|---|---|
| alOpOut.m_u32[i * 2 + 1] = c1_alIn1.m_u32[i*2 + 1] \hat{ } 0x80000000; | // negate |

imaginary

| | |
|---|---|
| | // portion |
| } else { | //Quadrant 00 |
| alOpOut.m_u32[i *2] = c1_alIn1.m_u32[i * 2] \hat{ } 0x00000000; | // use real |

portion

| | |
|---|---|
| alOpOut.m_u32[i * 2 + 1] = c1_alIn1.m_u32[i*2 + 1] \hat{ } 0x00000000; | // use imaginary |
| | //portion |

```
    }
  }
}
```

The following is an additional example of code (in the C language) that can be used to implement the pseudo code above:

| | |
|---|---|
| const double TwoXDivPi = kuTmpTimesR * TWO_DIV_PI; | //ord:2op #14 − Sin/Cosine 1 |

const double TwoXDivPiRounded = (TwoXDivPi + (TwoXDivPi > 0 ? 0.5 : −0.5)); // Special AlOp −
//PRoundF64

| trunc_f64_plus_lsbs_t nTrunc; | //ord:3 op #15 Sin/Cosine 2 | |
|---|---|---|
| | // Special AlOp − PTruncLsbsF64 | |
| | // Unary op | |
| | // | Zero fractional mantissa bits |
| | // | Set least significant 2 mantissa bits to: |
| | // | LSb = 2 \hat{ } 0 mantissa bit |
| | // | LSb+1= 2 \hat{ } 1 mantissa bit |

// Output is type trunc_f64_plus_lsbs_t

nTrunc.f64 = (double)(int) TwoXDivPiRounded;
int64_t nSint = (int) nTrunc.f64;
nTrunc.bits.n1 = !!((int) nSint & 1);
nTrunc.bits.n2 = !!((int) nSint & 2);

| | //ord:4op #16 − Sin/Cosine 3 | | |
|---|---|---|---|
| trunc_f64_plus_lsbs_t nTruncCopy = nTrunc; | // Special MsOp − PMulIgnore2Lsbs | | |
| | // | MsIn1 − type trunc_f64_plus_lsbs_t | |
| | // | msIn2 − type F64 | |
| | // | | Zero 2 lsbs of mantissa |
| | // | | MulF64 |

| | |
|---|---|
| // | Output is F64 |

nTruncCopy.bits.n1 = 0;
nTruncCopy.bits.n2 = 0;
double fsDMul = nTruncCopy.f64 * PI_DIV_TWO;
double fsD = kuTmpTimesR − fsDMul;

| complex g; | //ord:5 op #17 − Sin/Cosine 4 | |
|---|---|---|
| g.re = float(fsD * fsD); | // | F64 −> F32 conversion duplicates float |
| | // | g.im = g.re; |
| complex step2; | //ord:5op #18 − Sin/Cosine 4 | |
| step2.re = (float) fsD; | // | Special AlOp − PFromF64ToF32Const |

| | | |
|---|---|---|
| step2.im = 1.0 f; | // | AlIn 1 − type F64 |
| | // | AlIn2 − type F32 const in Lane 1 |
| | // | Converts AlIn1 to F32 −> Lane 0 |
| | // | of AlOut |
| | // | Copies AlIn2 to −> Lane 1 of |
| | // | ....AlOut. |

complex step3, step4, step5, step6;
step3.re = −0.0001984086154 f;
step3.im = −0.138885249433e−2 f;

| | |
|---|---|
| step4.re = 0.008333330973 f + step3.re * g.re; | //ord:6 op #19 − Sin/Cosine 5 |

step4.im = 0.416666506699e−1 f + step3.im * g.im;

| | |
|---|---|
| step5.re = −0.1666666660 f + step4.re * g.re; | //ord:7 op #20 − Sin/Cosine 6 |

step5.im = −0.499999998030 f + step4.im * g.im;

| | |
|---|---|
| step6.re = 1.0 f + step5.re * g.re; | //ord:8 op #21 − Sin/Cosine 7 |

step6.im = 1.0f + step5.im * g.im;
complex step7;

| | |
|---|---|
| step7.re = step6.re * step2.re; | //ord:9 op #22 − Sin/Cosine 8 |

step7.im = step6.im * step2.im;
complex matched_filter;

| if (nTrunc.bits.n1) { | // Special AlOp − PF32FromF64Rounded | |
|---|---|---|
| if (nTrunc.bits.n2) { | // | AlIn1 − type F32 |
| matched_filter.re = step7.re; | // | AlIn2 − trunc_f64_plus_lsbs_t |
| matched_filter.im = −step7.im; | // | Look at lsbs of AlIn2 n1, n2 |
| } else { | // | if (n1 && n2) negate AlOut.Lane0 |
| matched_filter.re = −step7.re; | // | if (n1 && In2) negate AlOut.Lane1 |
| matched_filter.im = step7.im; | // | if (In1 && n2) negate AlOut.Lanes 0 & 1 |
| } | // | if (In1 && In2) no change |

| | |
|---|---|
| } else { | // AlOut output type is F32 |

```
  if (nTrunc.bits.n2) {
    matched_filter.re = −step7.im;
    matched_filter.im = −step7.re;
  } else {
    matched_filter.re = step7.im;
    matched_filter.im = step7.re;
  }
}
```

These techniques of calculating sin and cosine for a vector architecture (e.g., SIMD processor) produces highly accurate thirty-two bit sin and cosine results from sixty-four bit angle values in a SIMD friendly manner. As demonstrated above, the least two significant bits of the IEEE 754 double-precision's 52-bit mantissa are sacrificed to store the unit circle quadrant. With hardware implemented special instructions above—to set, ignore for multiply and use these bits to correctly set the output value and sign—further efficiencies and ease of use can be obtained. For example, with these special instructions, conditionals that perform poorly in vector architectures can be avoided.

FIG. 7 illustrates an example of data flow of a fixed width value through hardware for concurrent sin and cosine determination, according to an embodiment. This data flow illustrates the progression of values in bit sequences. The original bit sequence 702 of an angle is processed to determine in which quadrant the angle is (operation 704). After the quadrant is determined, the original bit sequence is modified such that the least-two-significant-bits 708 hold an encoding for the quadrant while the remaining bits 706 are unchanged. Also, the value of the angle is reduced (e.g., translated into the first quadrant) to a single quadrant and placed in a second sequence of bits 710 (again, operation 704).

The second sequence of bits 710 is compacted and duplicated (operation 712) to create a combined cosine (real) and sine (imaginary) value 714 that is equal to the length of the second sequence of bits 710, The combined value 714 can be stored in the second sequence of bits (e.g., overwriting the quadrant reduced value) or stored in an addition sequence of bits.

The combined value 714 can be transmitted to hardware (e.g., HTF tiles or other SIMD devices) to calculate the sin and cosine components (operation 720) to produce intermediate values in a third sequence of bits 718. The intermediate values 718 and corrected to final values (operation 720) using the quadrant encoding 708 in the first sequence of bits 702. These final values can then be returned to a requestor of the sin and cosine operations.

FIG. 8A and FIG. 8B illustrate generally an example of a chiplet system that can be used to implement one or more aspects of the CNM system 102. As similarly mentioned above, a node in the CNN) system 102, or a device within a node in the CNM system 102, can include a chiplet-based architecture or compute-near-memory (CNM) chiplet. A packaged memory-compute device can include, for example, one, two, or four CNM chiplets. The chiplets can be interconnected using high-bandwidth, low-latency interconnects such as using a CPI interface. Generally, a chiplet system is made up of discrete modules (each a “chiplet”) that are integrated on an interposer and, in many examples, are interconnected as desired through one or more established networks to provide a system with the desired functionality. The interposer and included chiplets can be packaged together to facilitate interconnection with other components of a larger system. Each chiplet can include one or more individual integrated circuits (ICs), or “chips,” potentially in combination with discrete circuit components, and can be coupled to a respective substrate to facilitate attachment to the interposer. Most or all chiplets in a system can be individually configured for communication through established networks.

The configuration of chiplets as individual modules of a system is distinct from such a system being implemented on single chips that contain distinct device blocks (e.g., intellectual property (IP) blocks) on one substrate (e.g., single die), such as a system-on-a-chip (SoC), or multiple discrete packaged devices integrated on a printed circuit board (PCB). In general, chiplets provide better performance (e.g., lower power consumption, reduced latency, etc.) than discrete packaged devices, and chiplets provide greater production benefits than single die chips. These production benefits can include higher yields or reduced development costs and time.

Chiplet systems can include, for example, one or more application (or processor) chiplets and one or more support chiplets. Here, the distinction between application and support chiplets is simply a reference to the likely design scenarios for the chiplet system. Thus, for example, a synthetic vision chiplet system can include, by way of example only, an application chiplet to produce the synthetic vision output along with support chiplets, such as a memory controller chiplet, a sensor interface chiplet, or a communication chiplet. In a typical use case, the synthetic vision designer can design the application chiplet and source the support chiplets from other parties. Thus, the design expenditure (e.g., in terms of time or complexity) is reduced because by avoiding the design and production of functionality embodied in the support chiplets.

Chiplets also support the tight integration of IP blocks that can otherwise be difficult, such as those manufactured using different processing technologies or using different feature sizes (or utilizing different contact technologies or spacings). Thus, multiple ICs or IC assemblies, with different physical, electrical, or communication characteristics can be assembled in a modular manner to provide an assembly with various desired functionalities. Chiplet systems can also facilitate adaptation to suit needs of different larger systems into which the chiplet system will be incorporated. In an example, ICs or other assemblies can be optimized for the power, speed, or heat generation for a specific function—as can happen with sensors—can be integrated with other devices more easily than attempting to do so on a single die. Additionally, by reducing the overall size of the die, the yield for chiplets tends to be higher than that of more complex, single die devices.

FIG. 8A and FIG. 8B illustrate generally an example of a chiplet system, according to an embodiment. FIG. 8A is a representation of the chiplet system 802 mounted on a peripheral board 804, that can be connected to a broader computer system by a peripheral component interconnect express (PCIe), for example. The chiplet system 802 includes a package substrate 806, an interposer 808, and four chiplets, an application chiplet 810, a host interface chiplet 812, a memory controller chiplet 814, and a memory device chiplet 816. Other systems can include many additional chiplets to provide additional functionalities as will be apparent from the following discussion. The package of the chiplet system 802 is illustrated with a lid or cover 818, though other packaging techniques and structures for the chiplet system can be used. FIG. 8B is a block diagram labeling the components in the chiplet system for clarity.

The application chiplet 810 is illustrated as including a chiplet system NOC 820 to support a chiplet network 822 for inter-chiplet communications. In example embodiments the chiplet system NOC 820 can be included on the application chiplet 810. In an example, the first NOC 118 from the example of FIG. 1 can be defined in response to selected support chiplets (e.g., host interface chiplet 812, memory controller chiplet 814, and memory device chiplet 816) thus enabling a designer to select an appropriate number or chiplet network connections or switches for the chiplet system NOC 820. In an example, the chiplet system NOC 820 can be located on a separate chiplet, or within the interposer 808. In examples as discussed herein, the chiplet system NOC 820 implements a chiplet protocol interface (CPI) network.

In an example, the chiplet system 802 can include or comprise a portion of the first memory-compute node 104 or the first memory-compute device 112. That is, the various blocks or components of the first memory-compute device 112 can include chiplets that can be mounted on the peripheral board 804, the package substrate 806, and the interposer 808. The interface components of the first memory-compute device 112 can comprise, generally, the host interface chiplet 812, the memory and memory control-related components of the first memory-compute device 112 can comprise, generally, the memory controller chiplet 814, the various accelerator and processor components of the first memory-compute device 112 can comprise, generally, the application chiplet 810 or instances thereof, and so on.

The CPI interface, such as can be used for communication between or among chiplets in a system, is a packet-based network that supports virtual channels to enable a flexible and high-speed interaction between chiplets. CPI enables bridging from intra-chiplet networks to the chiplet network 822. For example, the Advanced eXtensible Interface (AXI) is a widely used specification to design intra-chip communications. AXI specifications, however, cover a great variety of physical design options, such as the number of physical channels, signal timing, power, etc. Within a single chip, these options are generally selected to meet design goals, such as power consumption, speed, etc. However, to achieve the flexibility of the chiplet system, an adapter, such as CPI, is used to interface between the various AXI design options that can be implemented in the various chiplets. By enabling a physical channel to virtual channel mapping and encapsulating time-based signaling with a packetized protocol, CPI bridges intra-chiplet networks across the chiplet network 822.

CPI can use a variety of different physical layers to transmit packets. The physical layer can include simple conductive connections, or can include drivers to increase the voltage, or otherwise facilitate transmitting the signals over longer distances. An example of one such a physical layer can include the Advanced Interface Bus (AIB), which in various examples, can be implemented in the interposer 808. AIB transmits and receives data using source synchronous data transfers with a forwarded clock. Packets are transferred across the AIB at single data rate (SDR) or dual data rate (DDR) with respect to the transmitted clock. Various channel widths are supported by AIB. The channel can be configured to have a symmetrical number of transmit (TX) and receive (RX) input/outputs (I/Os), or have a non-symmetrical number of transmitters and receivers (e.g., either all transmitters or all receivers). The channel can act as an AIB principal or subordinate depending on which chiplet provides the principal clock. AIB I/O cells support three clocking modes: asynchronous (i.e. non-clocked), SDR, and DDR. In various examples, the non-clocked mode is used for clocks and some control signals. The SDR mode can use dedicated SDR only I/O cells, or dual use SDR/DDR I/O cells.

In an example, CPI packet protocols (e.g., point-to-point or routable) can use symmetrical receive and transmit I/O cells within an AIB channel. The CPI streaming protocol allows more flexible use of the AIB I/O cells. In an example, an AIB channel for streaming mode can configure the I/O cells as all TX, all RX, or half TX and half RX. CPI packet protocols can use an AIB channel in either SDR or DDR operation modes. In an example, the AIB channel is configured in increments of 80 I/O cells (i.e. 40 TX and 40 RX) for SDR mode and 40 I/O cells for DDR mode. The CPI streaming protocol can use an AIB channel in either SDR or DDR operation modes. Here, in an example, the AIB channel is in increments of 40 I/O cells for both SDR and DDR modes. In an example, each AIB channel is assigned a unique interface identifier. The identifier is used during CPI reset and initialization to determine paired AIB channels across adjacent chiplets. In an example, the interface identifier is a 20-bit value comprising a seven-bit chiplet identifier, a seven-bit column identifier, and a six-bit link identifier. The AIB physical layer transmits the interface identifier using an AIB out-of-band shift register. The 20-bit interface identifier is transferred in both directions across an AIB interface using bits 32-51 of the shift registers.

AIB defines a stacked set of AIB channels as an AIB channel column. An AIB channel column has some number of AIB channels, plus an auxiliary channel. The auxiliary channel contains signals used for AIB initialization. All AIB channels (other than the auxiliary channel) within a column are of the same configuration (e.g., all TX, all RX, or half TX and half RX, as well as having the same number of data I/O signals). In an example, AIB channels are numbered in continuous increasing order starting with the AIB channel adjacent to the AUX channel. The AIB channel adjacent to the AUX is defined to be AIB channel zero.

Generally, CPI interfaces on individual chiplets can include serialization-deserialization (SERDES) hardware. SERDES interconnects work well for scenarios in which high-speed signaling with low signal count are desirable. SERDES, however, can result in additional power consumption and longer latencies for multiplexing and demultiplexing, error detection or correction (e.g., using block level cyclic redundancy checking (CRC)), link-level retry, or forward error correction. However, when low latency or energy consumption is a primary concern for ultra-short reach, chiplet-to-chiplet interconnects, a parallel interface with clock rates that allow data transfer with minimal latency can be utilized. CPI includes elements to minimize both latency and energy consumption in these ultra-short reach chiplet interconnects.

For flow control, CPI employs a credit-based technique. A recipient, such as the application chiplet 810, provides a sender, such as the memory controller chiplet 814, with credits that represent available buffers. In an example, a CPI recipient includes a buffer for each virtual channel for a given time-unit of transmission. Thus, if the CPI recipient supports five messages in time and a single virtual channel, the recipient has five buffers arranged in five rows (e.g., one row for each unit time). If four virtual channels are supported, then the recipient has twenty buffers arranged in five rows. Each buffer holds the payload of one CPI packet.

When the sender transmits to the recipient, the sender decrements the available credits based on the transmission. Once all credits for the recipient are consumed, the sender stops sending packets to the recipient. This ensures that the recipient always has an available buffer to store the transmission.

As the recipient processes received packets and frees buffers, the recipient communicates the available buffer space back to the sender. This credit return can then be used by the sender allow transmitting of additional information.

The example of FIG. 8A includes a chiplet mesh network 824 that uses a direct, chiplet-to-chiplet technique without a need for the chiplet system NOC 820. The chiplet mesh network 824 can be implemented in CPI, or another chiplet-to-chiplet protocol. The chiplet mesh network 824 generally enables a pipeline of chiplets where one chiplet serves as the interface to the pipeline while other chiplets in the pipeline interface only with themselves.

Additionally, dedicated device interfaces, such as one or more industry standard memory interfaces (such as, for example, synchronous memory interfaces, such as DDR5, DDR6), can be used to connect a device to a chiplet. Connection of a chiplet system or individual chiplets to external devices (such as a larger system can be through a desired interface (for example, a PCIe interface). Such an external interface can be implemented, in an example, through the host interface chiplet 812, which in the depicted example, provides a PCIe interface external to chiplet system. Such dedicated chiplet interfaces 826 are generally employed when a convention or standard in the industry has converged on such an interface. The illustrated example of a Double Data Rate (DDR) interface connecting the memory controller chiplet 814 to a dynamic random access memory (DRAM) memory device chiplet 816 is just such an industry convention.

Of the variety of possible support chiplets, the memory controller chiplet 814 is likely present in the chiplet system due to the near omnipresent use of storage for computer processing as well as sophisticated state-of-the-art for memory devices. Thus, using memory device chiplets 816 and memory controller chiplets 814 produced by others gives chiplet system designers access to robust products by sophisticated producers. Generally, the memory controller chiplet 814 provides a memory device-specific interface to read, write, or erase data. Often, the memory controller chiplet 814 can provide additional features, such as error detection, error correction, maintenance operations, or atomic operator execution. For some types of memory, maintenance operations tend to be specific to the memory device chiplet 816, such as garbage collection in NAND flash or storage class memories, temperature adjustments (e.g., cross temperature management) in NAND flash memories. In an example, the maintenance operations can include logical-to-physical (L2P) mapping or management to provide a level of indirection between the physical and logical representation of data. In other types of memory, for example DRAM, some memory operations, such as refresh can be controlled by a host processor or of a memory controller at some times, and at other times controlled by the DRAM memory device, or by logic associated with one or more DRAM devices, such as an interface chip (in an example, a buffer).

Atomic operators are a data manipulation that, for example, can be performed by the memory controller chiplet 814. In other chiplet systems, the atomic operators can be performed by other chiplets. For example, an atomic operator of “increment” can be specified in a command by the application chiplet 810, the command including a memory address and possibly an increment value. Upon receiving the command, the memory controller chiplet 814 retrieves a number from the specified memory address, increments the number by the amount specified in the command, and stores the result. Upon a successful completion, the memory controller chiplet 814 provides an indication of the command success to the application chiplet 810. Atomic operators avoid transmitting the data across the chiplet mesh network 824, resulting in lower latency execution of such commands.

Atomic operators can be classified as built-in atomics or programmable (e.g., custom) atomics. Built-in atomics are a finite set of operations that are immutably implemented in hardware. Programmable atomics are small programs that can execute on a programmable atomic unit (PAU) (e.g., a custom atomic unit (CAU)) of the memory controller chiplet 814.

The memory device chiplet 816 can be, or include any combination of, volatile memory devices or non-volatile memories. Examples of volatile memory devices include, but are not limited to, random access memory (RAM)—such as DRAM) synchronous DRAM (SDRAM), graphics double data rate type 6 SDRAM (GDDR6 SDRAM), among others. Examples of non-volatile memory devices include, but are not limited to, negative-and-(NAND)-type flash memory, storage class memory (e.g., phase-change memory or memristor based technologies), ferroelectric RAM (FeRAM), among others. The illustrated example includes the memory device chiplet 816 as a chiplet, however, the device can reside elsewhere, such as in a different package on the peripheral board 804. For many applications, multiple memory device chiplets can be provided. In an example, these memory device chiplets can each implement one or multiple storage technologies, and may include integrated compute hosts. In an example, a memory chiplet can include, multiple stacked memory die of different technologies, for example one or more static random access memory (SRAM) devices stacked or otherwise in communication with one or more dynamic random access memory (DRAM) devices. In an example, the memory controller chiplet 814 can serve to coordinate operations between multiple memory chiplets in the chiplet system 802, for example, to use one or more memory chiplets in one or more levels of cache storage, and to use one or more additional memory chiplets as main memory. The chiplet system 802 can include multiple memory controller chiplet 814 instances, as can be used to provide memory control functionality for separate hosts, processors, sensors, networks, etc. A chiplet architecture, such as in the illustrated system, offers advantages in allowing adaptation to different memory storage technologies; and different memory interfaces, through updated chiplet configurations, such as without requiring redesign of the remainder of the system structure.

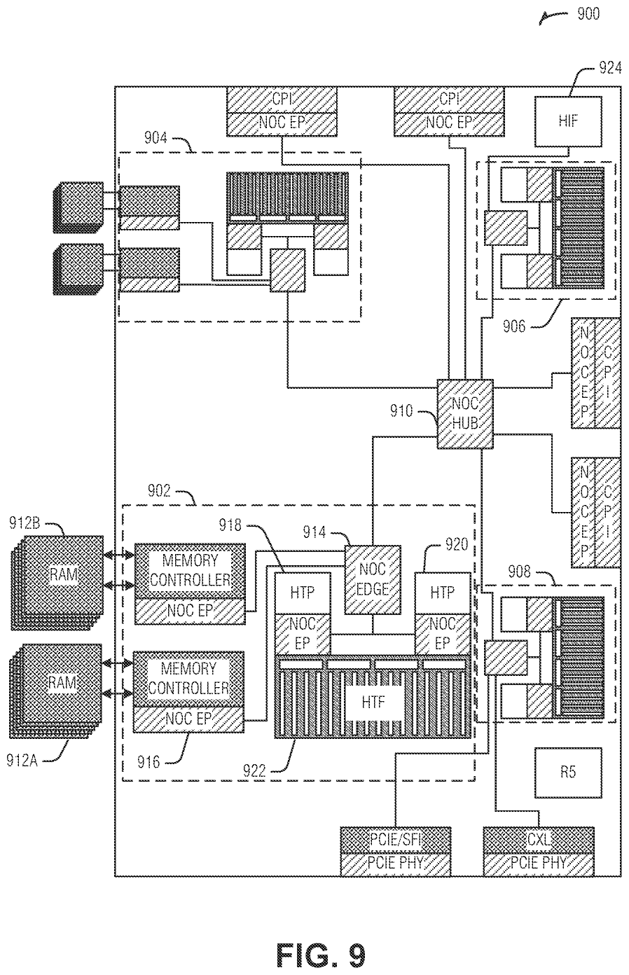

FIG. 9 illustrates generally an example of a chiplet-based implementation for a memory-compute device, according to an embodiment. The example includes an implementation with four compute-near-memory, or CNM, chiplets, and each of the CNM chiplets can include or comprise portions of the first memory-compute device 112 or the first memory-compute node 104 from the example of FIG. 1. The various portions can themselves include or comprise respective chiplets. The chiplet-based implementation can include or use CPI-based intra-system communications, as similarly discussed above in the example chiplet system 802 from FIG. 8A and FIG. 8B.

The example of FIG. 9 includes a first CNM package 900 comprising multiple chiplets. The first CNM package 900 includes a first chiplet 902, a second chiplet 904, a third chiplet 906, and a fourth chiplet 908 coupled to a CNM NOC hub 910. Each of the first through fourth chiplets can comprise instances of the same, or substantially the same, components or modules. For example, the chiplets can each include respective instances of an HTP accelerator, an HTF accelerator, and memory controllers for accessing internal or external memories.

In the example of FIG. 9, the first chiplet 902 includes a first NOC hub edge 914 coupled to the CNM NOC hub 910. The other chiplets in the first CNM package 900 similarly include NOC hub edges or endpoints. The switches in the NOC hub edges facilitate intra-chiplet, or intra-chiplet-system, communications via the CNM NOC hub 910.

The first chiplet 902 can further include one or multiple memory controllers 916. The memory controllers 916 can correspond to respective different NOC endpoint switches interfaced with the first NOC hub edge 914. In an example, the memory controller 916 comprises the memory controller chiplet 814 or comprises the memory controller 130, or comprises the memory subsystem 200, or other memory-compute implementation. The memory controllers 916 can be coupled to respective different memory devices, for example including a first external memory module 912A or a second external memory module 912B. The external memory modules can include, e.g., GDDR6 memories that can be selectively accessed by the respective different chiplets in the system.

The first chiplet 902 can further include a first HTP chiplet 918 and second HTP chiplet 920, such as coupled to the first NOC hub edge 914 via respective different NOC endpoint switches. The HTP chiplets can correspond to HTP accelerators, such as the HTP 140 from the example of FIG. 1, or the HTP accelerator 400 from the example of FIG. 4. The HTP chiplets can communicate with the HTF chiplet 922, The HTF chiplet 922 can correspond to an HTF accelerator, such as the HTF 142 from the example of FIG. 1, or the HTF 500 from the example of FIG. 5.

The CNM NOC hub 910 can be coupled to NOC hub instances in other chiplets or other CNM packages by way of various interfaces and switches. For example, the CNM NOC hub 910 can be coupled to a CPI interface by way of multiple different NOC endpoints on the first CNM package 900. Each of the multiple different NOC endpoints can be coupled, for example, to a different node outside of the first CNM package 900. In an example, the CNM NOC hub 910 can be coupled to other peripherals, nodes, or devices using CTCPI or other, non-CPI protocols. For example, the first CNM package 900 can include a PCIe scale fabric interface (PCIE/SFI) or a CXL interface (CXL) configured to interface the first CNM package 900 with other devices. In an example, devices to which the first CNM package 900 is coupled using the various CPI, PCIe, CXL, or other fabric, can make up a common global address space.

In the example of FIG. 9, the first CNM package 900 includes a host interface 924 (HIF) and a host processor (R5). The host interface 924 can correspond to, for example, the HIF 120 from the example of FIG. 1. The host processor, or R5, can correspond to the internal host processor 122 from the example of FIG. 1. The host interface 924 can include a PCI interface for coupling the first CNM package 900 to other external devices or systems. In an example, work can be initiated on the first CNM package 900, or a tile cluster within the first CNM package 900, by the host interface 924. For example, the host interface 924 can be configured to command individual HTF tile clusters, such as among the various chiplets in the first CNM package 900, into and out of power/clock gate modes.

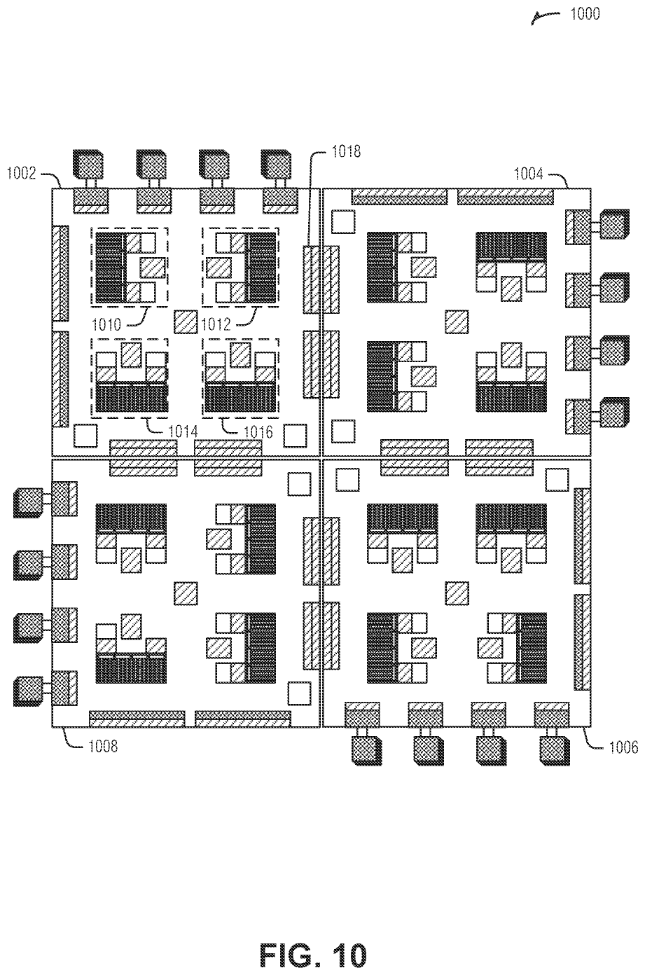

FIG. 10 illustrates an example tiling of memory-compute devices, according to an embodiment. In FIG. 10, a tiled chiplet example 1000 includes four instances of different compute-near-memory clusters of chiplets, where the clusters are coupled together. Each instance of a compute-near-memory chiplet can itself include one or more constituent chiplets (e.g., host processor chiplets, memory device chiplets, interface chiplets, and so on).

The tiled chiplet example 1000 includes, as one or multiple of its compute-near-memory (CNM) clusters, instances of the first CNM package 900 from the example of FIG. 9. For example, the tiled chiplet example 1000 can include a first CNM cluster 1002 that includes a first chiplet 1010 (e.g., corresponding to the first chiplet 902), a second chiplet 1012 (e.g., corresponding to the second chiplet 904), a third chiplet 1014 (e.g., corresponding to the third chiplet 906), and a fourth chiplet 1016 (e.g., corresponding to the fourth chiplet 908). The chiplets in the first CNM cluster 1002 can be coupled to a common NOC hub, which in turn can be coupled to a NOC hub in an adjacent cluster or clusters (e.g., in a second CNM cluster 1004 or a fourth CNM cluster 1008).

In the example of FIG. 10, the tiled chiplet example 1000 includes the first CNM cluster 1002, the second CNM cluster 1004, a third CNM cluster 1006, and the fourth CNM cluster 1008. The various different CNM chiplets can be configured in a common address space such that the chiplets can allocate and share resources across the different tiles. In an example, the chiplets in the cluster can communicate with each other. For example, the first CNM cluster 1002 can be communicatively coupled to the second CNM cluster 1004 via an inter-chiplet CPI interface 1018, and the first CNM cluster 1002 can be communicatively coupled to the fourth CNM cluster 1008 via another or the same CPI interface. The second CNM cluster 1004 can be communicatively coupled to the third CNM cluster 1006 via the same or other CPI interface, and so on.

In an example, one of the compute-near-memory chiplets in the tiled chiplet example 1000 can include a host interface (e.g., corresponding to the host interface 924 from the example of FIG. 9) that is responsible for workload balancing across the tiled chiplet example 1000. The host interface can facilitate access to host-based command request queues and response queues, such as from outside of the tiled chiplet example 1000. The host interface can dispatch new threads of execution using hybrid threading processors and the hybrid threading fabric in one or more of the compute-near-memory chiplets in the tiled chiplet example 1000.

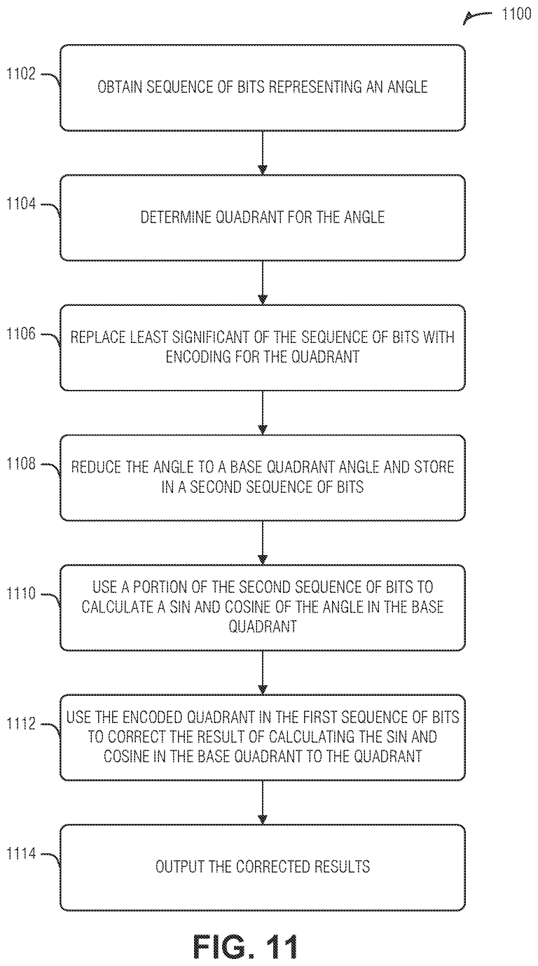

FIG. 11 is a flow chart of an example of a method 1100 for hardware for concurrent SINE and cosine determination, according to an embodiment. Operations of the method 1100 are performed by computer hardware, such as that described with respect to FIGS. 1-5, 8A-10 and 12, such as the memory-compute device 112, the memory controller 200, the PAU 208 or PAU 302, the HTP 400, or the HTF 500, or components therein in various combinations. Computer hardware performing the operations of the method 1100 includes processing circuitry configured (e.g., hardwired, by software including firmware, or a combination of the two) to implement the operations.

At operation 1102, a first sequence of bits representing an angle of a line from an origin to a unit circle is obtained (e.g., received or retrieved). In an example, the processing circuitry is an HTF and the first sequence of bits is obtained from a first lane of the HTF. In an example, the first sequence of bits is sixty-four bits.

At operation 1104, a quadrant of the unit circle for the line is determined from the angle. In an example, the processing circuitry includes a hardware block for determining the quadrant.

At operation 1106, the two least significant bits of the first sequence of bits are replaced with an encoding for the quadrant.

At operation 1108, the angle is reduced to a base quadrant angle in a second sequence of bits that is a same length as the first sequence of bits. In an example, reducing the angle to the base quadrant angle in the second sequence of bits includes subtracting the encoded quadrant times ninety degrees

$$( e . g . , \frac{π}{2} )$$

from the angle to produce a result that is stored in the second sequence of bits. In an example, the base quadrant angle is squared before storing the in the second sequence of bits.

At operation 1110, sin and cosine operations (e.g., calculations) are performed on a portion of the second sequence of bits to create an intermediate sin solution and an intermediate cosine solution in the base quadrant. In an example, the portion of the second sequence of bits has a length in bits that is one half that of the first sequence of bits. In an example, the portion of the second sequence of bits is thirty-two bits.

At operation 1112, the encoding for the quadrant in the first sequence of bits is used on the intermediate sin solution and the intermediate cosine solution to create a final sin solution and a final cosine solution in the quadrant.

At operation 1114, a third sequence of bits representing the final sin solution and the final cosine solution is output. In an example, the third sequence of bits is equal to the length of the first sequence of bits (e.g., a lane width for an HTF). In an example, the third sequence of bits is output on a second lane of the HTF. In an example, the first lane or the second lane of the HTF connects directly to a tile in the HTF or to a HTP. In an example, the HTF is included in a memory-compute device that includes the HTP. In an example, the memory-compute device is included in a memory compute node of a compute-near memory system.

As noted with respect to FIG. 6, the possible quadrants can be a first quadrant— between −45 degrees (e.g., 315 degrees) and 45 degrees, a second quadrant from 45 to 135 degrees, a third quadrant from 135 to 225 degrees, and a fourth quadrant from 225 to 315 degrees. In this context, when the quadrant is the first quadrant—according to the encoding for the quadrant in the first sequence of bits—converting the intermediate sin solution and the intermediate cosine solution to create the final sin solution and the final cosine solution includes using the intermediate sin solution as the final sin solution and using the intermediate cosine solution as the final cosine solution. That is, here, nothing is changed, and this quadrant is the base quadrant. However, if the quadrant is the second quadrant in an example, then a negation of the intermediate cosine solution is used as the final sin solution and a negation of the intermediate sin solution is used as the final cosine solution. Accordingly, in an example where the quadrant is the third quadrant, then a negation of the intermediate sin solution is used as the final sin solution and the intermediate cosine solution is used as the final cosine solution. In an example, where the quadrant is the fourth quadrant, then the intermediate sin solution is used as the final sin solution and a negation of the intermediate cosine solution is used as the final cosine solution.

In an example, performing the sin and cosine operations on the portion of the second sequence of hits to create an intermediate sin solution and an intermediate cosine solution in the base quadrant includes copying thirty-two of the most significant bits of the second sequence of bits to a first part of a sixty-four bit value. Then, the thirty-two of the most significant bits of the second sequence of bits are copied to a second part of the sixty-four bit value. Sin operations are performed on one part (e.g., the first half) of the second sequence of bits and cosine operations are performed on another part of the second sequence of bits (e.g., the second half). In an example, an output from the sin operations replace the first part of the sixty-four bit value and the cosine operations replace the second part of the sixty-four bit value. Here, the first part and the second part respectively refer to the bits upon which the sin operation and the cosine operation were respectively performed. Thus, if the second half of the second sequence of bits were used as input to the sin calculation, then the first part in which the output is stored is the second half of the second sequence of bits.

In an example, the intermediate sin solution and the intermediate cosine solution in the base quadrant are stored within the third sequence of bits. Here, the processing circuitry includes a hardware block that accepts the first sequence of bits with the quadrant encoded and the second sequence of bits to create the final sin solution and the final cosign solution. In an example, the first sequence of bits are a variable to Euler's formula, the final sin solution is an imaginary part of the solution to Euler's formula with the variable, and the final cosine solution is a real part of the solution to Euler's formula with the variable,

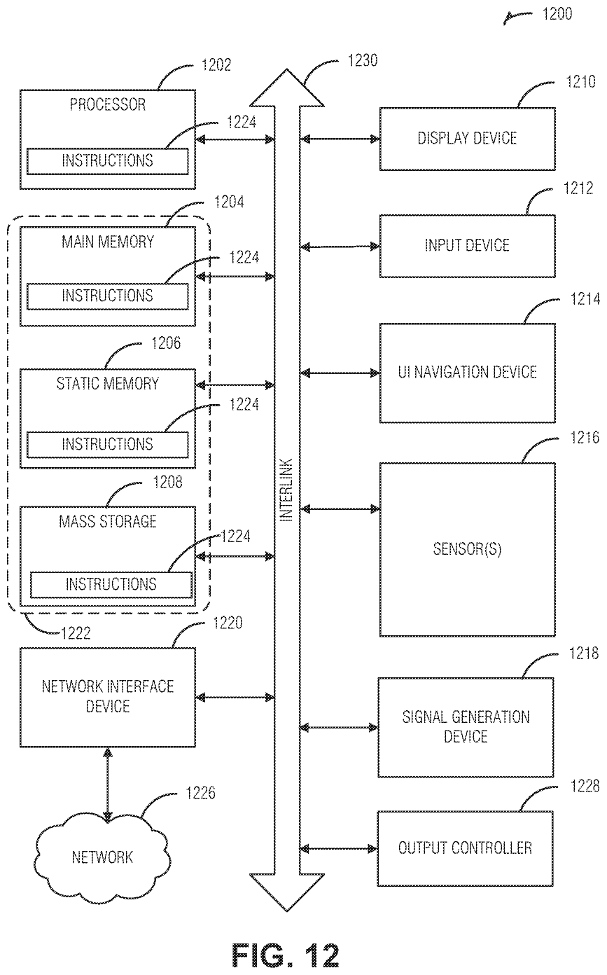

FIG. 12 illustrates a block diagram of an example machine 1200 with which, in which, or by which any one or more of the techniques (e.g., methodologies) discussed herein can be implemented. Examples, as described herein, can include, or can operate by, logic or a number of components, or mechanisms in the machine 1200. Circuitry (e.g., processing circuitry) is a collection of circuits implemented in tangible entities of the machine 1200 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 1200.

In alternative embodiments, the machine 1200 can operate as a standalone device or can be connected (e.g., networked) to other machines. In a networked deployment, the machine 1200 can operate in the capacity of a server machine, a client machine, or both in server-client network environments. In an example, the machine 1200 can act as a peer machine in peer-to-peer (P2P) (or other distributed) network environment. The machine 1200 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1200 (e.g., computer system) can include a hardware processor 1202 (e.g., a central processing unit (CPU), a graphics processing unit (GPU), a hardware processor core, or any combination thereof), a main memory 1204, a static memory 1206 (e.g., memory or storage for firmware, microcode, a basic-input-output (BIOS), unified extensible firmware interface (UEFI), etc.), and mass storage device 1208 (e.g., hard drives, tape drives, flash storage, or other block devices) some or all of which can communicate with each other via an interlink 1230 (e.g., bus). The machine 1200 can further include a display device 1210, an alphanumeric input device 1212 (e.g., a keyboard), and a user interface (UI) Navigation device 1214 (e.g., a mouse). In an example, the display device 1210, the input device 1212, and the UI navigation device 1214 can be a touch screen display. The machine 1200 can additionally include a mass storage device 1208 (e.g., a drive unit), a signal generation device 1218 (e.g., a speaker), a network interface device 1220, and one or more sensor(s) 1216, such as a global positioning system (GPS) sensor, compass, accelerometer, or other sensor. The machine 1200 can include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 1202, the main memory 1204, the static memory 1206, or the mass storage device 1208 can be, or include, a machine-readable media 1222 on which is stored one or more sets of data structures or instructions 1224 (e.g., software) embodying or used by any one or more of the techniques or functions described herein. The instructions 1224 can also reside, completely or at least partially, within any of registers of the hardware processor 1202, the main memory 1204, the static memory 1206, or the mass storage device 1208 during execution thereof by the machine 1200. In an example, one or any combination of the hardware processor 1202, the main memory 1204, the static memory 1206, or the mass storage device 1208 can constitute the machine-readable media 1222. While the machine-readable media 1222 is illustrated as a single medium, the term “machine-readable medium” can include a single medium or multiple media (e.g., a centralized or distributed database, or associated caches and servers) configured to store the one or more instructions 1224.

The term “machine readable medium” can include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 1222 can be representative of the instructions 1224, such as instructions 1224 themselves or a format from which the instructions 1224 can be derived. This format from which the instructions 1224 can be derived can include source code, encoded instructions (e.g., in compressed or encrypted form), packaged instructions (e.g., split into multiple packages), or the like. The information representative of the instructions 1224 in the machine-readable media 1222 can be processed by processing circuitry into the instructions to implement any of the operations discussed herein. For example, deriving the instructions 1224 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1224.

In an example, the derivation of the instructions 1224 can include assembly, compilation, or interpretation of the information (e.g., by the processing circuitry) to create the instructions 1224 from some intermediate or preprocessed format provided by the machine-readable media 1222. The information, when provided in multiple parts, can be combined, unpacked, and modified to create the instructions 1224. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1224 can be further transmitted or received over a communications network 1226 using a transmission medium via the network interface device 1220 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1220 can include one or more physical jacks (e.g., Ethernet, coaxial, or phone jacks) or one or more antennas to connect to the network 1226. In an example, the network interface device 1220 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1200, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is an apparatus comprising: a first port for a first lane, the first lane having a width in bits; a second port a second lane, the second lane having the same width as the first lane, wherein the apparatus is part of a Hybrid Threading Fabric (HTF), and wherein the first lane and the second lane are lanes of the HTF; and processing circuitry configured to: obtain, from the first port, a first sequence of bits representing an angle of a line from an origin to a unit circle; determine a quadrant of the unit circle for the line; replace two least significant bits of the first sequence of bits with an encoding for the quadrant; reduce the angle to a base quadrant angle in a second sequence of bits that is a same length as the first sequence of bits; perform sin and cosine operations on a portion of the second sequence of bits to create an intermediate sin solution and an intermediate cosine solution in the base quadrant; use the encoding for the quadrant in the first sequence of bits on the intermediate sin solution and the intermediate cosine solution to create a final sin solution and a final cosine solution in the quadrant; and output a third sequence of bits representing the final sin solution and the final cosine solution, wherein the third sequence of bits is equal to the length of the first sequence of bits, wherein the third sequence of bits is output on the second port, and wherein a width of any lane of the HTF is equal to the first sequence of bits.

In Example 2, the subject matter of Example 1 includes, wherein the quadrant is a first quadrant, and wherein, to use the encoding for the quadrant in the first sequence of bits on the intermediate sin solution and the intermediate cosine solution to create a final sin solution and a final cosine solution, the processing circuitry is configured to: use the intermediate sin solution as the final sin solution; and use the intermediate cosine solution as the final cosine solution.

In Example 3, the subject matter of Examples 1-2 includes, wherein the quadrant is a second quadrant, and wherein, to use the encoding for the quadrant in the first sequence of bits on the intermediate sin solution and the intermediate cosine solution to create a final sin solution and a final cosine solution, the processing circuitry is configured to: use a negation of the intermediate cosine solution as the final sin solution; and use a negation of the intermediate sin solution as the final cosine solution.

In Example 4, the subject matter of Examples 1-3 includes, wherein the quadrant is a third quadrant, and wherein, to use the encoding for the quadrant in the first sequence of bits on the intermediate sin solution and the intermediate cosine solution to create a final sin solution and a final cosine solution, the processing circuitry is configured to: use a negation of the intermediate sin solution as the final sin solution; and use the intermediate cosine solution as the final cosine solution.

In Example 5, the subject matter of Examples 1˜4 includes, wherein the quadrant is a fourth quadrant, and wherein, to use the encoding for the quadrant in the first sequence of bits on the intermediate sin solution and the intermediate cosine solution to create a final sin solution and a final cosine solution, the processing circuitry is configured to: use the intermediate sin solution as the final sin solution; and use a negation of the intermediate cosine solution as the final cosine solution.

In Example 6, the subject matter of Examples 1-5 includes, wherein the first lane or the second lane of the HTF connects directly to a tile in the HTF or to a Hybrid Threading Processor (HTP).

In Example 7, the subject matter of Example 6 includes, wherein the HTF is included in a memory-compute device that includes the HTP.

In Example 8, the subject matter of Example 7 includes, wherein the memory-compute device is included in a memory compute node of a compute-near memory system.

In Example 9, the subject matter of Examples 1-8 includes, wherein the first sequence of bits is sixty-four bits.

In Example 10, the subject matter of Examples 1-9 includes, wherein the portion of the second sequence of bits has a length in bits that is one half that of the first sequence of bits.

In Example 11, the subject matter of Example 10 includes, wherein the portion of the second sequence of bits is thirty-two bits.

In Example 12, the subject matter of Example 11 includes, wherein, to perform the sin and cosine operations on the portion of the second sequence of bits to create an intermediate sin solution and an intermediate cosine solution in the base quadrant, the processing circuitry is configured to: copy thirty-two of most significant bits of the second sequence of bits to a first part of a sixty-four bit value; copy the thirty-two of the most significant bits of the second sequence of bits to a second part of the sixty-four bit value; perform the sin operations on the first part of the sixty-four bit value; and perform the cosine operations on the second part of the sixty-four bit value.

In Example 13, the subject matter of Example 12 includes, wherein an output from the sin operations replaces the first part of the sixty-four bit value, and wherein the cosine operations replace the second part of the sixty-four bit value.

In Example 14, the subject matter of Examples 1-13 includes, wherein the processing circuitry includes a hardware block for determining the quadrant.

In Example 15, the subject matter of Examples 1-14 includes, wherein the intermediate sin solution and the intermediate cosine solution in the base quadrant are stored within the third sequence of bits, and wherein the processing circuitry includes a hardware block that accepts the first sequence of bits with the quadrant encoded and the second sequence of bits to create the final sin solution and the final cosine solution.

In Example 16, the subject matter of Examples 1-15 includes, wherein the first sequence of bits is a variable to Euler's formula, and wherein the final sin solution is an imaginary part of a solution to Euler's formula with the variable, and wherein the final cosine solution is a real part of the solution to Euler's formula with the variable.

In Example 17, the subject matter of Examples 1-16 includes, wherein, to reduce the angle to the base quadrant angle in the second sequence of bits, the processing circuitry is configured to subtract the encoded quadrant times ninety degrees from the angle to produce a result that is stored in the second sequence of bits.

In Example 18, the subject matter of Example 17 includes, wherein, to reduce the angle to the base quadrant angle in the second sequence of bits, the processing circuitry is configured to square the result before storing the in the second sequence of bits.

In Example 19, the subject matter of Examples 1-18 includes, wherein the base quadrant is between negative forty five degrees and forty five degrees inclusive.

Example 20 is a method comprising: obtaining, by processing circuitry, a first sequence of bits representing an angle of a line from an origin to a unit circle, wherein the processing circuitry is part of a Hybrid Threading Fabric (HTF), wherein the first sequence of bits is obtained from a first lane of the HTF; determining, by the processing circuitry, a quadrant of the unit circle for the line; replacing, by the processing circuitry, two least significant bits of the first sequence of bits with an encoding for the quadrant; reducing the angle to a base quadrant angle in a second sequence of bits that is a same length as the first sequence of bits; performing sin and cosine operations on a portion of the second sequence of bits to create an intermediate sin solution and an intermediate cosine solution in the base quadrant; using, by the processing circuitry, the encoding for the quadrant in the first sequence of bits on the intermediate sin solution and the intermediate cosine solution to create a final sin solution and a final cosine solution in the quadrant; and outputting, by the processing circuitry, a third sequence of bits representing the final sin solution and the final cosine solution, wherein the third sequence of bits is equal to the length of the first sequence of bits, wherein the third sequence of bits is output on a second lane of the HTF, and wherein a width of any lane of the HTF is equal to the first sequence of bits.

In Example 21, the subject matter of Example 20 includes, wherein the quadrant is a first quadrant, and wherein using the encoding for the quadrant in the first sequence of bits on the intermediate sin solution and the intermediate cosine solution to create a final sin solution and a final cosine solution includes: using the intermediate sin solution as the final sin solution; and using the intermediate cosine solution as the final cosine solution.

In Example 22, the subject matter of Examples 20-21 includes, wherein the quadrant is a second quadrant, and wherein using the encoding for the quadrant in the first sequence of bits on the intermediate sin solution and the intermediate cosine solution to create a final sin solution and a final cosine solution includes: using a negation of the intermediate cosine solution as the final sin solution; and using a negation of the intermediate sin solution as the final cosine solution.

In Example 23, the subject matter of Examples 20-22 includes, wherein the quadrant is a third quadrant, and wherein using the encoding for the quadrant in the first sequence of bits on the intermediate sin solution and the intermediate cosine solution to create a final sin solution and a final cosine solution includes: using a negation of the intermediate sin solution as the final sin solution; and using the intermediate cosine solution as the final cosine solution.

In Example 24, the subject matter of Examples 20-23 includes, wherein the quadrant is a fourth quadrant, and wherein using the encoding for the quadrant in the first sequence of bits on the intermediate sin solution and the intermediate cosine solution to create a final sin solution and a final cosine solution includes: using the intermediate sin solution as the final sin solution; and using a negation of the intermediate cosine solution as the final cosine solution.

In Example 25, the subject matter of Examples 20-24 includes, wherein the first lane or the second lane of the HTF connects directly to a tile in the HTF or to a Hybrid Threading Processor (HTP).

In Example 26, the subject matter of Example 25 includes, wherein the HTF is included in a memory-compute device that includes the HTP.

In Example 27, the subject matter of Example 26 includes, wherein the memory-compute device is included in a memory compute node of a compute-near memory system.

In Example 28, the subject matter of Examples 20-27 includes, wherein the first sequence of bits is sixty-four bits.

In Example 29, the subject matter of Examples 20-28 includes, wherein the portion of the second sequence of bits has a length in bits that is one half that of the first sequence of bits.

In Example 30, the subject matter of Example 29 includes, wherein the portion of the second sequence of bits is thirty-two bits.

In Example 31, the subject matter of Example 30 includes, wherein performing the sin and cosine operations on the portion of the second sequence of bits to create an intermediate sin solution and an intermediate cosine solution in the base quadrant includes: copying thirty-two of most significant bits of the second sequence of bits to a first part of a sixty-four bit value; copying the thirty-two of the most significant bits of the second sequence of bits to a second part of the sixty-four bit value; performing the sin operations on the first part of the sixty-four bit value; and performing the cosine operations on the second part of the sixty-four bit value.

In Example 32, the subject matter of Example 31 includes, wherein an output from the sin operations replaces the first part of the sixty-four bit value, and wherein the cosine operations replace the second part of the sixty-four bit value.

In Example 33, the subject matter of Examples 20-32 includes, wherein the processing circuitry includes a hardware block for determining the quadrant.

In Example 34, the subject matter of Examples 20-33 includes, wherein the intermediate sin solution and the intermediate cosine solution in the base quadrant are stored within the third sequence of bits, and wherein the processing circuitry includes a hardware block that accepts the first sequence of bits with the quadrant encoded and the second sequence of bits to create the final sin solution and the final cosine solution.

In Example 35, the subject matter of Examples 20-34 includes, wherein the first sequence of bits is a variable to Euler's formula, and wherein the final sin solution is an imaginary part of a solution to Euler's formula with the variable, and wherein the final cosine solution is a real part of the solution to Euler's formula with the variable.

In Example 36, the subject matter of Examples 20-35 includes, wherein reducing the angle to the base quadrant angle in the second sequence of bits includes subtracting the encoded quadrant times ninety degrees from the angle to produce a result that is stored in the second sequence of bits.

In Example 37, the subject matter of Example 36 includes, wherein reducing the angle to the base quadrant angle in the second sequence of bits includes squaring the result before storing the in the second sequence of bits.

In Example 38, the subject matter of Examples 20-37 includes, wherein the base quadrant is between negative forty five degrees and forty five degrees inclusive.

Example 39 is a machine-readable medium including instructions that, when executed by processing circuitry, cause the processing circuitry to perform operations comprising: obtaining a first sequence of bits representing an angle of a line from an origin to a unit circle, wherein the processing circuitry is part of a Hybrid Threading Fabric (HTF), wherein the first sequence of bits is obtained from a first lane of the HTF; determining a quadrant of the unit circle for the line; replacing two least significant bits of the first sequence of bits with an encoding for the quadrant; reducing the angle to a base quadrant angle in a second sequence of bits that is a same length as the first sequence of bits; performing sin and cosine operations on a portion of the second sequence of bits to create an intermediate sin solution and an intermediate cosine solution in the base quadrant; using the encoding for the quadrant in the first sequence of bits on the intermediate sin solution and the intermediate cosine solution to create a final sin solution and a final cosine solution in the quadrant; and outputting a third sequence of bits representing the final sin solution and the final cosine solution, wherein the third sequence of bits is equal to the length of the first sequence of bits, wherein the third sequence of bits is output on a second lane of the HTF, and wherein a width of any lane of the HTF is equal to the first sequence of bits.

In Example 40, the subject matter of Example 39 includes, wherein the quadrant is a first quadrant, and wherein using the encoding for the quadrant in the first sequence of bits on the intermediate sin solution and the intermediate cosine solution to create a final sin solution and a final cosine solution includes: using the intermediate sin solution as the final sin solution; and using the intermediate cosine solution as the final cosine solution.

In Example 41, the subject matter of Examples 39-40 includes, wherein the quadrant is a second quadrant, and wherein using the encoding for the quadrant in the first sequence of bits on the intermediate sin solution and the intermediate cosine solution to create a final sin solution and a final cosine solution includes: using a negation of the intermediate cosine solution as the final sin solution; and using a negation of the intermediate sin solution as the final cosine solution.

In Example 42, the subject matter of Examples 39-41 includes, wherein the quadrant is a third quadrant, and wherein using the encoding for the quadrant in the first sequence of bits on the intermediate sin solution and the intermediate cosine solution to create a final sin solution and a final cosine solution includes: using a negation of the intermediate sin solution as the final sin solution; and using the intermediate cosine solution as the final cosine solution.

In Example 43, the subject matter of Examples 39-42 includes, wherein the quadrant is a fourth quadrant, and wherein using the encoding for the quadrant in the first sequence of bits on the intermediate sin solution and the intermediate cosine solution to create a final sin solution and a final cosine solution includes: using the intermediate sin solution as the final sin solution; and using a negation of the intermediate cosine solution as the final cosine solution.

In Example 44, the subject matter of Examples 39-43 includes, wherein the first lane or the second lane of the HTF connects directly to a tile in the HTF or to a Hybrid Threading Processor (HTP).

In Example 45, the subject matter of Example 44 includes, wherein the HTF is included in a memory-compute device that includes the HTP.

In Example 46, the subject matter of Example 45 includes, wherein the memory-compute device is included in a memory compute node of a compute-near memory system.

In Example 47, the subject matter of Examples 39-46 includes, wherein the first sequence of bits is sixty-four bits.

In Example 48, the subject matter of Examples 39-47 includes, wherein the portion of the second sequence of bits has a length in bits that is one half that of the first sequence of bits.

In Example 49, the subject matter of Example 48 includes, wherein the portion of the second sequence of bits is thirty-two bits.

In Example 50, the subject matter of Example 49 includes, wherein performing the sin and cosine operations on the portion of the second sequence of bits to create an intermediate sin solution and an intermediate cosine solution in the base quadrant includes: copying thirty-two of most significant bits of the second sequence of bits to a first part of a sixty-four bit value; copying the thirty-two of the most significant bits of the second sequence of bits to a second part of the sixty-four bit value; performing the sin operations on the first part of the sixty-four bit value; and performing the cosine operations on the second part of the sixty-four bit value.

In Example 51, the subject matter of Example 50 includes, wherein an output from the sin operations replaces the first part of the sixty-four bit value, and wherein the cosine operations replace the second part of the sixty-four bit value.

In Example 52, the subject matter of Examples 39-51 includes, wherein the processing circuitry includes a hardware block for determining the quadrant.

In Example 53, the subject matter of Examples 39-52 includes, wherein the intermediate sin solution and the intermediate cosine solution in the base quadrant are stored within the third sequence of bits, and wherein the processing circuitry includes a hardware block that accepts the first sequence of bits with the quadrant encoded and the second sequence of bits to create the final sin solution and the final cosine solution.

In Example 54, the subject matter of Examples 39-53 includes, wherein the first sequence of bits is a variable to Euler's formula, and wherein the final sin solution is an imaginary part of a solution to Euler's formula with the variable, and wherein the final cosine solution is a real part of the solution to Euler's formula with the variable.

In Example 55, the subject matter of Examples 39-54 includes, wherein reducing the angle to the base quadrant angle in the second sequence of bits includes subtracting the encoded quadrant times ninety degrees from the angle to produce a result that is stored in the second sequence of bits.

In Example 56, the subject matter of Example 55 includes, wherein reducing the angle to the base quadrant angle in the second sequence of bits includes squaring the result before storing the in the second sequence of bits.

In Example 57, the subject matter of Examples 39-56 includes, wherein the base quadrant is between negative forty five degrees and forty five degrees inclusive.

Example 58 is a system comprising: means for obtaining a first sequence of bits representing an angle of a line from an origin to a unit circle, wherein the system is part of a Hybrid Threading Fabric (HTF), wherein the first sequence of bits is obtained from a first lane of the HTF; means for determining a quadrant of the unit circle for the line; means for replacing two least significant bits of the first sequence of bits with an encoding for the quadrant; means for reducing the angle to a base quadrant angle in a second sequence of bits that is a same length as the first sequence of bits; means for performing sin and cosine operations on a portion of the second sequence of bits to create an intermediate sin solution and an intermediate cosine solution in the base quadrant; means for using the encoding for the quadrant in the first sequence of bits on the intermediate sin solution and the intermediate cosine solution to create a final sin solution and a final cosine solution in the quadrant; and means for output a third sequence of bits representing the final sin solution and the final cosine solution, wherein the third sequence of bits is equal to the length of the first sequence of bits, wherein the third sequence of bits is output on a second lane of the HTF, and wherein a width of any lane of the HTF is equal to the first sequence of bits.

In Example 59, the subject matter of Example 58 includes, wherein the quadrant is a first quadrant, and wherein the means for using the encoding for the quadrant in the first sequence of bits on the intermediate sin solution and the intermediate cosine solution to create a final sin solution and a final cosine solution include: means for using the intermediate sin solution as the final sin solution; and means for using the intermediate cosine solution as the final cosine solution.

In Example 60, the subject matter of Examples 58-59 includes, wherein the quadrant is a second quadrant, and wherein the means for using the encoding for the quadrant in the first sequence of bits on the intermediate sin solution and the intermediate cosine solution to create a final sin solution and a final cosine solution include: means for using a negation of the intermediate cosine solution as the final sin solution; and means for using a negation of the intermediate sin solution as the final cosine solution.

In Example 61, the subject matter of Examples 58-60 includes, wherein the quadrant is a third quadrant, and wherein the means for using the encoding for the quadrant in the first sequence of bits on the intermediate sin solution and the intermediate cosine solution to create a final sin solution and a final cosine solution include: means for using a negation of the intermediate sin solution as the final sin solution; and means for using the intermediate cosine solution as the final cosine solution.

In Example 62, the subject matter of Examples 58-61 includes, wherein the quadrant is a fourth quadrant, and wherein the means for using the encoding for the quadrant in the first sequence of bits on the intermediate sin solution and the intermediate cosine solution to create a final sin solution and a final cosine solution include: means for using the intermediate sin solution as the final sin solution; and means for using a negation of the intermediate cosine solution as the final cosine solution.

In Example 63, the subject matter of Examples 58-62 includes, wherein the first lane or the second lane of the HTF connects directly to a tile in the HTF or to a Hybrid Threading Processor (HTP).

In Example 64, the subject matter of Example 63 includes, wherein the HTF is included in a memory-compute device that includes the HTP.

In Example 65, the subject matter of Example 64 includes, wherein the memory-compute device is included in a memory compute node of a compute-near memory system.

In Example 66, the subject matter of Examples 58-65 includes, wherein the first sequence of bits is sixty-four bits.

In Example 67, the subject matter of Examples 58-66 includes, wherein the portion of the second sequence of bits has a length in bits that is one half that of the first sequence of bits.

In Example 68, the subject matter of Example 67 includes, wherein the portion of the second sequence of bits is thirty-two bits.

In Example 69, the subject matter of Example 68 includes, wherein the means for performing the sin and cosine operations on the portion of the second sequence of bits to create an intermediate sin solution and an intermediate cosine solution in the base quadrant include: means for copying thirty-two of most significant bits of the second sequence of bits to a first part of a sixty-four bit value; means for copying the thirty-two of the most significant bits of the second sequence of bits to a second part of the sixty-four bit value; means for performing the sin operations on the first part of the sixty-four bit value; and means for performing the cosine operations on the second part of the sixty-four bit value.

In Example 70, the subject matter of Example 69 includes, wherein an output from the sin operations replaces the first part of the sixty-four bit value, and wherein the cosine operations replace the second part of the sixty-four bit value.

In Example 71, the subject matter of Examples 58-70 includes, wherein the system includes a hardware block for determining the quadrant.

In Example 72, the subject matter of Examples 58-71 includes, wherein the intermediate sin solution and the intermediate cosine solution in the base quadrant are stored within the third sequence of bits, and wherein the system includes a hardware block that accepts the first sequence of bits with the quadrant encoded and the second sequence of bits to create the final sin solution and the final cosine solution.

In Example 73, the subject matter of Examples 58-72 includes, wherein the first sequence of bits is a variable to Euler's formula, and wherein the final sin solution is an imaginary part of a solution to Euler's formula with the variable, and wherein the final cosine solution is a real part of the solution to Euler's formula with the variable.

In Example 74, the subject matter of Examples 58-73 includes, wherein the means for reducing the angle to the base quadrant angle in the second sequence of bits include means for subtracting the encoded quadrant times ninety degrees from the angle to produce a result that is stored in the second sequence of bits.

In Example 75, the subject matter of Example 74 includes, wherein the means for reducing the angle to the base quadrant angle in the second sequence of bits include means for squaring the result before storing the in the second sequence of bits.

In Example 76, the subject matter of Examples 58-75 includes, wherein the base quadrant is between negative forty five degrees and forty five degrees inclusive.

Example 77 is at least one machine-readable medium including instructions that, when executed by processing circuitry, cause the processing circuitry to perform operations to implement of any of Examples 1-76.

Example 78 is an apparatus comprising means to implement of any of Examples 1-76.

Example 79 is a system to implement of any of Examples 1-76.

Example 80 is a method to implement of any of Examples 1-76.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An apparatus comprising:
a first port for a first lane, the first lane having a width in bits;
a second port for a second lane, the second lane having the same width as the first lane, wherein the apparatus is part of a Hybrid Threading Fabric (HTF), and wherein the first lane and the second lane are lanes of the HTF; and
processing circuitry configured to:
obtain, from the first port, a first sequence of bits representing an angle of a line from an origin to a unit circle;
determine a quadrant of the unit circle for the line;
replace two least significant bits of the first sequence of bits with an encoding for the quadrant;
reduce the angle to a base quadrant angle in a second sequence of bits that is a same length as the first sequence of bits;
perform sine and cosine operations on a portion of the second sequence of bits to create an intermediate sine solution and an intermediate cosine solution in the base quadrant;
use the encoding for the quadrant in the first sequence of bits on the intermediate sine solution and the intermediate cosine solution to create a final sin solution and a final cosine solution in the quadrant; and
output a third sequence of bits representing the final sine solution and the final cosine solution, wherein the third sequence of bits is equal to the length of the first sequence of bits, wherein the third sequence of bits is output on the second port, and wherein a width of any lane of the HTF is equal to the first sequence of bits.

2. The apparatus of claim 1, wherein the quadrant is a first quadrant, and wherein, to use the encoding for the quadrant in the first sequence of bits on the intermediate sin solution and the intermediate cosine solution to create a final sin solution and a final cosine solution, the processing circuitry is configured to:
use the intermediate sin solution as the final sin solution; and
use the intermediate cosine solution as the final cosine solution.

3. The apparatus of claim 1, wherein the quadrant is a second quadrant, and wherein, to use the encoding for the quadrant in the first sequence of bits on the intermediate sin solution and the intermediate cosine solution to create a final sin solution and a final cosine solution, the processing circuitry is configured to:
use a negation of the intermediate cosine solution as the final sin solution; and
use a negation of the intermediate sin solution as the final cosine solution.

4. The apparatus of claim 1, wherein the quadrant is a third quadrant, and wherein, to use the encoding for the quadrant in the first sequence of bits on the intermediate sin solution and the intermediate cosine solution to create a final sin solution and a final cosine solution, the processing circuitry is configured to:
use a negation of the intermediate sin solution as the final sin solution; and
use the intermediate cosine solution as the final cosine solution.

5. The apparatus of claim 1, wherein the quadrant is a fourth quadrant, and wherein, to use the encoding for the quadrant in the first sequence of bits on the intermediate sin solution and the intermediate cosine solution to create a final sin solution and a final cosine solution, the processing circuitry is configured to:
use the intermediate sin solution as the final sin solution; and
use a negation of the intermediate cosine solution as the final cosine solution.

6. The apparatus of claim 1, wherein the first lane or the second lane of the HTF connects directly to a tile in the HTF or to a Hybrid Threading Processor (HTP).

7. The apparatus of claim 6, wherein the HTF is included in a memory-compute device that includes the HTP.

8. The apparatus of claim 7, wherein the memory-compute device is included in a memory compute node of a compute-near memory system.

9. The apparatus of claim 1, wherein the first sequence of bits is sixty-four bits.

10. The apparatus of claim 1, wherein the portion of the second sequence of bits has a length in hits that is one half that of the first sequence of hits.

11. The apparatus of claim 10, wherein the portion of the second sequence of bits is thirty-two bits.

12. The apparatus of claim 11, wherein, to perform the sin and cosine operations on the portion of the second sequence of bits to create an intermediate sin solution and an intermediate cosine solution in the base quadrant, the processing circuitry is configured to:
convert the second sequence of bits from a double to a float and store in a first part of a sixty-four hit value;
store the float to a second part of the sixty-four bit value;
perform the sin operations on the first part of the sixty-four bit value; and
perform the cosine operations on the second part of the sixty-four bit value.

13. The apparatus of claim 12, wherein an output from the sin operations replaces the first part of the sixty-four bit value, and wherein the cosine operations replace the second part of the sixty-four bit value.

14. The apparatus of claim 1, wherein the processing circuitry includes a hardware block for determining the quadrant.

15. The apparatus of claim 1, wherein the intermediate sin solution and the intermediate cosine solution in the base quadrant are stored within the third sequence of bits, and wherein the processing circuitry includes a hardware block that accepts the first sequence of bits with the quadrant encoded and the second sequence of bits to create the final sin solution and the final cosine solution.

16. The apparatus of claim 1, wherein the first sequence of bits is a variable to Euler's formula, and wherein the final sin solution is an imaginary part of a solution to Euler's formula with the variable, and wherein the final cosine solution is a real part of the solution to Euler's formula with the variable.

17. The apparatus of claim 1, wherein, to reduce the angle to the base quadrant angle in the second sequence of bits, the processing circuitry is configured to subtract the encoded quadrant times ninety degrees from the angle to produce a result that is stored in the second sequence of bits.

18. The apparatus of claim 17, wherein, to reduce the angle to the base quadrant angle in the second sequence of bits, the processing circuitry is configured to square the result before storing the in the second sequence of bits.

19. The apparatus of claim 1, wherein the base quadrant is between negative forty five degrees and forty five degrees inclusive.

20. A machine-readable medium including instructions that, when executed by processing circuitry, cause the processing circuitry to perform operations comprising:
obtaining a first sequence of bits representing an angle of a line from an origin to a unit circle, wherein the processing circuitry is part of a Hybrid Threading Fabric (HTF), wherein the first sequence of bits is obtained from a first lane of the HTF;
determining a quadrant of the unit circle for the line;
replacing two least significant bits of the first sequence of bits with an encoding for the quadrant;
reducing the angle to a base quadrant angle in a second sequence of bits that is a same length as the first sequence of bits;
performing sin and cosine operations on a portion of the second sequence of bits to create an intermediate sin solution and an intermediate cosine solution in the base quadrant;
using the encoding for the quadrant in the first sequence of bits on the intermediate sin solution and the intermediate cosine solution to create a final sin solution and a final cosine solution in the quadrant; and
outputting a third sequence of bits representing the final sin solution and the final cosine solution, wherein the third sequence of bits is equal to the length of the first sequence of bits, wherein the third sequence of bits is output on a second lane of the HTF, and wherein a width of any lane of the HTF is equal to the first sequence of bits.

21. The machine-readable medium of claim 20, wherein the quadrant is a first quadrant, and wherein using the encoding for the quadrant in the first sequence of bits on the intermediate sin solution and the intermediate cosine solution to create a final sin solution and a final cosine solution includes:
using the intermediate sin solution as the final sin solution; and
using the intermediate cosine solution as the final cosine solution.

22. The machine-readable medium of claim 20, wherein the quadrant is a second quadrant, and wherein using the encoding for the quadrant in the first sequence of bits on the intermediate sin solution and the intermediate cosine solution to create a final sin solution and a final cosine solution includes:
using a negation of the intermediate cosine solution as the final sin solution; and
using a negation of the intermediate sin solution as the final cosine solution.

23. The machine-readable medium of claim 20, wherein the quadrant is a third quadrant, and wherein using the encoding for the quadrant in the first sequence of bits on the intermediate sin solution and the intermediate cosine solution to create a final sin solution and a final cosine solution includes:
using a negation of the intermediate sin solution as the final sin solution; and
using the intermediate cosine solution as the final cosine solution.

24. The machine-readable medium of claim 20, wherein the quadrant is a fourth quadrant, and wherein using the encoding for the quadrant in the first sequence of bits on the intermediate sin solution and the intermediate cosine solution to create a final sin solution and a final cosine solution includes:
using the intermediate sin solution as the final sin solution; and
using a negation of the intermediate cosine solution as the final cosine solution.
